(19) United States
(12) Patent Application Publication
(10) Pub. No.: US 2025/0109757 A1
(43) Pub. Date: Apr. 3, 2025

(54) MULTIPLE-VENTURI NOZZLE, SYSTEM, METHOD OF MANUFACTURE AND METHOD OF USE

(71) Applicant: Gideon Vandegrift, Sarasota, FL (US)

(72) Inventor: Gideon Vandegrift, Sarasota, FL (US)

(21) Appl. No.: 18/480,157

(22) Filed: Oct. 3, 2023

(51) Int. Cl. F15D 1/02

(52) U.S. Cl. CPC F15D 1/02

(57) ABSTRACT

The first object of the present invention is directed to a High Flow Venturi Nozzle capable of diffusing gas into a large quantity of fast-moving liquid. Another object of the present invention is directed to a two-piece High Flow Venturi Nozzle assembly. Another object of the present invention is directed to a method of manufacturing and using the two embodiments noted above. The second object of the instant invention includes a multiple-Venturi nozzle and a system, method of manufacture and method of using same.

The present application is a non-provisional application which claims priority to U.S. Provisional Patent Application No. 63/378,269 filed Oct. 4, 2022 and entitled “MULTIPLE-VENTURI NOZZLE, SYSTEM, METHOD AND MANUFACTURE AND METHOD OF USE,” the contents of which is incorporated herein by reference in its entirety.

### BACKGROUND OF THE INVENTION

First discovered by the Italian physicist Giovanni Battista Venturi in 1797, the “Venturi effect” is the name for a natural phenomenon that sees a reduction in fluid pressure when a fluid flows through a constricted section (or choke) of a pipe. In an idealize state, an incompressible fluid's: (a) velocity must increase as it passes through a constriction under the principle of mass continuity; and (b) static pressure must decrease as it passes through a constriction under the principle of conservation of mechanical energy (i.e., Bernoulli's principle). Put another way, any “gain” in kinetic energy a fluid attains by its increased velocity through a constriction is balanced by a “drop” in pressure.

The Venturi effect has a number of practical applications wherein a Venturi nozzle takes advantage of the above-mentioned pressure drop to mix gas and liquid; including: aerators, atomizers, and carburetors. In the case of mixing oxygen into water, a Venturi microbubble generator can be used to create a large number of very small bubbles; accomplishing several things. First, the size of the bubbles allows such bubbles to remain suspended in the water for longer periods-increasing the amount of oxygen which will dissolve into the water. Second, the small sized bubbles have a very high surface area to volume ratio-increasing the amount of oxygen which will dissolve into the water by increasing the total effective surface area of air in contact with water.

Historically, various attempts were made to use more than one Venturi nozzle in combination with one another. One such attempt is disclosed in UK Patent Application GB2439380A (Priest) which teaches an aeration apparatus which makes use of the Venturi effect.

Another such attempt is disclosed in CN 202492409U (Jia) which teaches a Venturi-type radial jet aerator which makes use of more than one Venturi nozzle.

Another such attempt is disclosed in U.S. Pat. No. 4,966,001 (Beebe) which teaches a multiple Venturi tube gas fuel injector for a catalytic combustor.

Another such attempt is disclosed in U.S. Pat. No. 7,854,637 (Schultz) which teaches a multiple Venturi nozzle system for watercraft.

Another such attempt is disclosed in U.S. Pat. No. 2,797,904 (Voorheis) which teaches a multiple Venturi air scrubber.

Another such attempt is disclosed in U.S. Pat. No. 2,760,371 (Borden) which teaches a multiple Venturi tube.

Another such apparatus for exploring oxygenation effect of multiple Venturi air ejectors CN203869853U (Xiangju) which discloses a test apparatus for exploring the oxygenation effect of multiple Venturi air ejectors.

### SUMMARY OF THE INVENTION

The first main object of the present invention is directed to a High Flow Venturi Nozzle (“HFVN”) apparatus capable of diffusing gas into a large quantity of fast-moving liquid. The HFVN has a high flow relative to the Multiple-Venturi Nozzle (as discussed below). For example, in many water-treatment and aquacultural applications, it is necessary to diffuse air (or other gasses) into a fast-moving stream of water. As noted above, Traditional Venturi Nozzles generally are unable to do this; however, the present invention is capable of accommodating a high flow rate while still accomplishing the task of diffusing gas into the high-flow liquid.

Another object of the present invention is an embodiment of the HFVN generally comprising: (a) a body having at least one choke extending through said body; (b) a manifold (to which an outside gas supply can be connected); (c) at least one manifold outlet connected to each choke; and (d) an internal “path” system connecting the manifold to each manifold outlet (and, thus, to each choke). In this way, when a gas is connected to the manifold (e.g., by connecting a gas supply to the manifold via a tube and using a manifold nipple), the gas will flow from the manifold, through the internal “path” system and out into the choke through the manifold outlets. Thus, when a fluid (especially a fluid which is flowing quickly) is passed through the chokes, a Venturi effect will occur at each manifold outlet.

Another object of the present invention is an HFVN Assembly generally comprising: (a) a female cap; and a (b) male cap; which is designed to be inserted into a pipe with a tee having a tee opening (commonly known as a “reducing tee”). The female cap has a body and a protruding flange. The female cap also has a centrally located hole which extends throughout both the body and the flange. The male cap likewise has a body, a protruding flange and a centrally located hole which extends throughout both the body and the flange. However, the male body further comprises at least one (preferably a plurality) of fins and manifold outlets. When the male and female caps are joined together inside a pipe: (i) they define a pocket of space whereby the tee opening is in fluid communion with the manifold outlets; and (ii) they form a type of “choke” since the female cap opening and the male cap opening align to form one continuing opening. This allows water (or some other liquid) to flow through the pipe-creating a Venturi effect at the manifold outlets. When the tee is connected to a gas source (e.g., air), such gas will be drawn into the pocket and through the manifold outlets where it will be diffused into the water (or other liquid).

Another object of the present invention is an HFVN Assembly wherein the manifold outlets further comprise a plurality of manifold outlets. In certain embodiments, these manifold outlets could be pinhole manifold outlets or larger manifold outlets. The dimensioning of the manifold outlets is generally relative to the diameter of the choke, the characteristics and desired flow rate of the fluid and the nature, pressure and desired diffusion rate of the gas.

The second main object of the present invention is directed to a Multiple-Venturi Nozzle (“MVN”) apparatus having: (a) a plurality of Venturi nozzles spaced around a central recess; (b) the central recess having gas lines to each of the Venturi nozzles so that a fluid passed through the MVN is mixed with a gas which flows out of the central recess through the gas lines-forming small bubbles. This increases the quantity of gas bubbles and reduces the size of gas bubbles (allowing for better dissolution of the gas into the liquid than traditional Venturi nozzles). The instant multiple-Venturi nozzle has a generally cylindrical body with a generally flat bottom surface and a generally flat distal outer surface and a generally arcuate vertical surface parallel to the bottom and outer surfaces. The instant multiple-Venturi nozzle further includes a plurality of chokes generally perpendicular to the bottom and outer surfaces, each of said chokes extending through the body and having a choke inlet and a choke outlet. The instant multiple-Venturi nozzle further includes a manifold extending from the outer surface partially into the body and a plurality of manifold channels connecting the manifold to each choke, each of said manifold channels being generally perpendicular to a corresponding choke, having a manifold outlet and a distal manifold inlet and being offset in a helical distribution from other manifold outlets corresponding to the same choke.

Importantly, many conventional Venturi systems have a relatively high liquid/gas mixture velocity at the nozzle-outlet. This can limit the usefulness of such Venturi systems for many applications including the use of such systems in aquaculture or agricultural projects (e.g., hydroponics, aquaponics, etc.) since the high velocity can damage plant (especially root structures) and marine life. The instant invention allows for a lower exit flow rate by making use of: (a) multiple Venturi nozzles; and (b) the plurality of gas lines.

An additional object of the present invention is directed to an MVN with a plurality of chokes, manifold outlets, manifold channels and manifold inlets (as defined in the “Detailed Description” section below) in a generally helical structure (i.e., the distribution of manifold outlets is made in a corkscrew like pattern). This allows for: (a) the placement of Venturi nozzles in “layers” such that the gas inlet is perpendicular to the flow of the fluid; and (b) a far greater density of Venturi nozzles than has ever been possible before. By heaving each of the manifold channels offset from one another, the space between each “layer” can be made thinner, i.e., less material can be used to construct the MVN and a greater effective density of Venturi nozzles can be obtained for a given “width” of the MVN.

The number of Venturi nozzles in each “layer” is controlled by the number of chokes contained in each such layer (to which there is no theoretical limit). Moreover, such number of Venturi nozzles increases linearly with the number of “layers” which are present. This is only limited by the materials used and the manufacturing techniques employed to separate each “layer”. To maximize the number of chokes in any given layer, additional manifold rings and manifold passages can be used as illustrated herein.

Indeed, the embodiment shown in the drawings (e.g., FIGS. 13A through 13L) has been actually prototyped and tested. This device has thirteen (13) chokes each of which has at least nine (9) gas lines. Thus, each device has the effective capacity of at least 117 (i.e., 13×9) Venturi nozzles. In the prototyping done thus far, such device is approximately one inch in diameter. This high effective “density” of Venturi nozzles in such a small device has yielded unexpected results. Experimentation has shown that the use of an MVN in connection with oxygenating water allows for a greater rate of oxygen dissolution (i.e., a better rate of oxygenation of the water) using a less powerful pump as compared with traditional Venturi aerators. In another embodiment, a plurality of manifolds could be used-thus allowing the MVN to simultaneously draw more than one gas into the liquid stream passing through the chokes. For example, in a two-manifold MVN system, a first gas and a second gas could be simultaneously diffused into a single stream of liquid using only one pump for such liquid. This has particular application in waste-water treatment applications where multiple gasses may be diffused into waste water at a given time.

An additional object of the present invention is directed to a system containing: (a) at least one MVN; and (b) a pipe; and (c) a gas line. More specifically, the instant invention includes a system in which a plurality of MVNs are used in an external manifold to increase the effective flow rate and the effective gas dissolution rate within such a system. For example, a one to four external manifold could be used in connection with four MVNs (one at each outlet of the external manifold). By doing say, the fluid flow rate at each of the external manifold's outlets would be one fourth the flow rate at the external manifold's inlet. Such a system can be used as a preliminary means of “stepping down” the flow of fluids.

An additional object of the present invention is directed to a method of manufacturing an MVN using three-dimensional (“3D”) printing technology. More specifically, because of: (a) the plurality of gas lines (also called “manifold channels” herein); and (b) the generally helical structure of such manifold channels; the most effective way to construct an MVN is through the use of 3D printers. Thus, the size of each hole (i.e., manifold channel) can be made as small as the minimum thickness of material which a given 3D printer can extrude (often fractions of a millimeter). In the preferred embodiment, each manifold channel is offset both vertically and at a slight angle to the horizontal-resulting in a helical distribution of manifold channels. This is done to add further strength and to ensure that the pressure through each manifold channel does not result in a deformation of the material or a breach from one manifold channel to another. As illustrated in the figures below and as borne out by experimentation, this allows for creating an MVN with any desired number of Venturi or any desired flow/dissolution characteristics. Thus, for example, an MVN can be made with relatively few chokes for a low-flow rate application or with relatively many chokes for a higher-flow rate application.

An additional object of the present invention is directed to a method of using an MVN. As discussed elsewhere herein, the MVN is connected within an outer housing (e.g., a pipe) and a liquid (or a gas) is passed through same (through the chokes). A second liquid or gas is fed to a manifold within the MVN and drawn through the plurality of holes. Where a gas is diffused into a liquid, a micro-cavitation of the gas occurs-resulting in a high rate of dissolution of the gas into the liquid.

### BRIEF DESCRIPTION OF THE DRAWINGS

FIG. 1 is a side view of an HFVN having a height h showing a plane A̅B̅ through the body of the HFVN.

FIG. 2 is a front perspective view of an HFVN segment (taken along plane A̅B̅ from FIG. 1) having a height hₛ and having a plurality of chokes and a single manifold.

FIG. 3A is a rear perspective view of an HFVN segment (taken along plane A̅B̅ from FIG. 1) showing the interior structure of the HFVN.

FIG. 3B is a rear view of an HFVN segment (taken along plane A̅B̅ from FIG. 1) showing the interior structure of the HFVN.

FIG. 4A is a front perspective view of an HFVN having a plurality of chokes and a single manifold.

FIG. 4B is a rear view of an HFVN having a plurality of chokes and a single manifold.

FIG. 5 is a compilation showing several views of an HFVN having a plurality of chokes and a single manifold.

FIG. 6A is a side view of an HFVN assembly having a plurality of fins and manifold outlets.

FIG. 6B is a front view of a female cap portion of an HFVN assembly.

FIG. 6C is a side vide of a female cap portion of an HFVN assembly

FIG. 6D is a rear view of a male cap portion of an HFVN assembly.

FIG. 6E is a side vide of a male cap portion of an HFVN assembly.

FIG. 7A is a side exploded view of an HFVN assembly and a pipe having a tee.

FIG. 7B is a perspective exploded view of an HFVN assembly and a pipe having a tee.

FIG. 7C is a perspective view of an HFVN assembly attached to a Pipe having a Tee.

FIG. 8A is a side cutaway view of an HFVN assembly (comprising a female cap and a male cap.

FIG. 8B is a perspective cutaway view of an HFVN assembly (comprising a female cap and a male cap).

FIG. 9A is a compilation showing different views of two embodiments of HFVN assemblies.

FIG. 9B is a compilation showing several different view of three embodiments of HFVN assemblies.

FIG. 10A is a compilation of different front, side and perspective views of a top piece of a two-piece HFVN.

FIG. 10B is a compilation of different front, side and perspective view of a bottom piece of a two-piece HFVN.

FIG. 10C is a compilation of a side and perspective cutaway view of a two-piece HFVN.

FIG. 10D is a compilation of different side, perspective and rear views of an assembled two-piece HFVN.

FIG. 11A is a top perspective view of an MVN having at least one choke and a manifold.

FIG. 11B is a perspective cutaway view of an MVN taken along the plane AB shown in FIG. 11A.

FIG. 12A is a stylized side view of a MVN having at least one choke.

FIG. 12B is a stylized side view of an MVN which has been inserted into an outer pipe.

FIGS. 13A through 13L depict sequential perspective views of the process of manufacturing a MVN using 3D printing.

FIG. 14A through FIG. 14C depict sequential perspective views of the process of manufacturing an alternative embodiment of an MVN using 3D printing.

FIG. 15 is an enlargement of a MVN showing enlarged details of a finished choke and manifold.

FIG. 16 shows a top perspective view of a MVN having a plurality of manifolds each having a manifold nipple and a plurality of chokes.

FIG. 17 shows top perspective views of two MVNs having differently sized chokes.

FIG. 18 shows top perspective views of seven different sizes of MVNs each having a different number/distribution pattern of chokes.

FIG. 19A shows a side view of one embodiment of an apparatus having a manifold and a plurality of chokes, with each choke connected to the manifold through an orifice.

FIG. 19B shows a front view of one embodiment of an apparatus having a manifold and a plurality of chokes, with each choke connected to the manifold through an orifice.

FIG. 19C shows a rear view of one embodiment of an apparatus having a manifold and a plurality of chokes, with each choke connected to the manifold through an orifice.

FIG. 19D shows a front perspective view of one embodiment of an apparatus having a manifold and a plurality of chokes, with each choke connected to the manifold through an orifice.

FIG. 19E shows a rear cutaway view of an apparatus having a manifold and a plurality of chokes, with each choke connected to the manifold through an orifice.

FIG. 19F shows a rear, perspective cutaway view of an apparatus having a manifold and a plurality of chokes, with each choke connected to the manifold through an orifice.

FIG. 19G shows a front, perspective cutaway view of an apparatus having a manifold and a plurality of chokes, with each choke connected to the manifold through an orifice.

FIG. 20A shows a front view of a male member of an apparatus having a plurality of male choke members.

FIG. 20B shows side view of a male member of an apparatus having a plurality of male choke members.

FIG. 20C shows a rear perspective view of a male member of an apparatus having a plurality of male choke members.

FIG. 21A shows a front view of a female member of an apparatus having a plurality of female choke members.

FIG. 21B shows a side view of a female member of an apparatus having a plurality of chokes with each choke having a flared tip and a gap.

FIG. 21C shows a rear perspective view of a female member of an apparatus having a plurality of chokes with each choke having a flared tip and a gap.

FIG. 22A shows a side view of an apparatus comprising a female member and a male member.

FIG. 22B shows a rotated side view of an apparatus comprising a female member and a male member.

FIG. 22C shows a perspective rear view of an apparatus comprising a female member and a male member.

FIG. 22D shows a side view of an apparatus comprising a female member and a male member within a cutaway pipe having a tee.

FIG. 23 shows a stylized drawing of a side view of an apparatus within a cutaway pipe having a tee.

### REFERENCE NUMERAL CHART

For purposes of describing the preferred embodiment, the terminology used in reference to the number components in the drawings is as follows:

| | |
|---|---|
| 100 | High Flow Venturi Nozzle (“HFVN”) |
| 100a | High Flow Venturi Nozzle (“HFVN”) Segment |
| hₛ | Segment Height |
| 101 | Body |
| 102 | Top Surface |
| 103 | Choke |
| 105 | Choke Inlet |
| 107 | Choke Outlet |
| 109 | Manifold |
| 111 | Manifold Nipple |
| 113 | Manifold Inlet |
| 115 | Manifold Channel |
| 117 | Manifold Outlet |
| 119 | Manifold Passage |
| 121 | Bottom Surface |
| H | Height |
| 200 | HFVN Assembly |
| 201 | Female Cap |
| 202 | Female Cap Opening |
| 203 | Male Cap |
| 204 | Male Cap Opening |
| 205 | Fins |
| 207 | Manifold Outlets |
| 209 | Female Body |
| 211 | Female Flange |
| 213 | Male Body |
| 215 | Male Flange |
| 216 | Pocket |
| 217 | Pipe |
| 219 | Tee |
| 221 | Tee Opening |
| 223 | Manifold Outlets |
| 300 | Two-Piece HFVN |
| 301 | Top Piece |
| 302 | Top Surface |
| 303 | Bottom Piece |
| 304 | Bottom Surface |
| 305 | Manifold |
| 307 | Manifold Nipple |
| 309 | Top Chamber |
| 311 | Bottom Chamber |
| 313a | Top Choke |
| 313b | Bottom Choke |
| 315 | Manifold Outlet |
| 400 | Multiple-Venturi Nozzle (“MVN”) |
| 401 | Medium |
| 403 | Choke |
| 403a | Choke Inlet |
| 403b | Choke Outlet |
| 405 | Manifold Outlet |
| 407 | Manifold Channel |
| 409 | Manifold Inlet |
| 411 | Manifold |
| 413 | Outer Surface |
| 415 | Manifold Nipple |
| 416 | Bottom Edge |
| 417 | Vertical Surface |
| 418 | Bottom Surface |
| 419 | Manifold Back |
| 421 | Pipe |
| 423 | Manifold Ring |
| 425 | Manifold Passage |
| P_{1A} | Initial Pressure |
| P_{1B} | Choke Pressure |
| P_{1C} | Final Pressure |
| P₂ | Second Pressure |

### DETAILED DESCRIPTION OF THE INVENTION

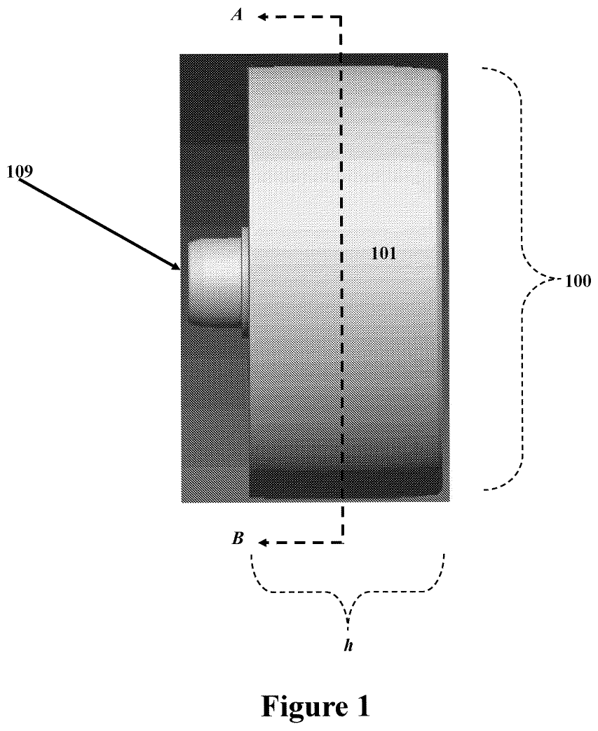

FIG. 1 is a side view of an HFVN 100 having a Body 101 and a height h. The HFVN 100 shown in FIG. 1 includes a centrally located Manifold 109. FIG. 1 further depicts a plane through the Body 101 of the HFVN 100 and parallel to the Manifold 109.

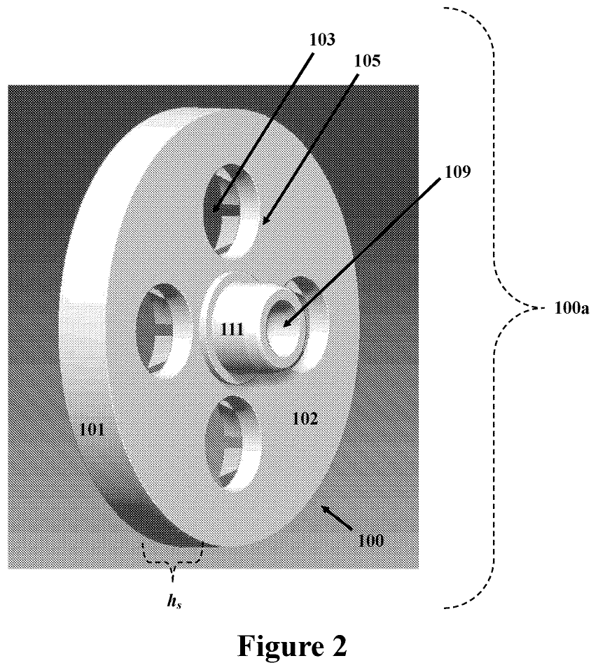

FIG. 2 is a front perspective view of an HFVN Segment 100a (taken along plane A̅B̅ from FIG. 1) having a height hₛ. The HFVN 100 has at least one Manifold 109. In the embodiment shown in FIG. 2, the HFVN 100 includes a single Manifold 109 which is centrally located in the HFVN 100. The HFVN 100 further comprises a plurality of Chokes 103; each of which has a Choke Inlet 105 and a Choke Outlet 107 (not shown in FIG. 2) and extends from a Top Surface 102 of the HFVN 100 to a Bottom Surface 121 (not shown in FIG. 2) of the HFVN 100. In the embodiment shown in FIG. 2, the HFVN 100 includes four Chokes 103 which are equidistantly distributed in a radial pattern about the Manifold 109. A Manifold Nipple 111 extends outwardly from the Top Surface 102 of the HFVN 100. This manifold Nipple 111 may be dimensionally sized to accommodate a variety of hoses/tubing which, in turn, can be connected to a gas supply such as an air supply or an oxygen supply.

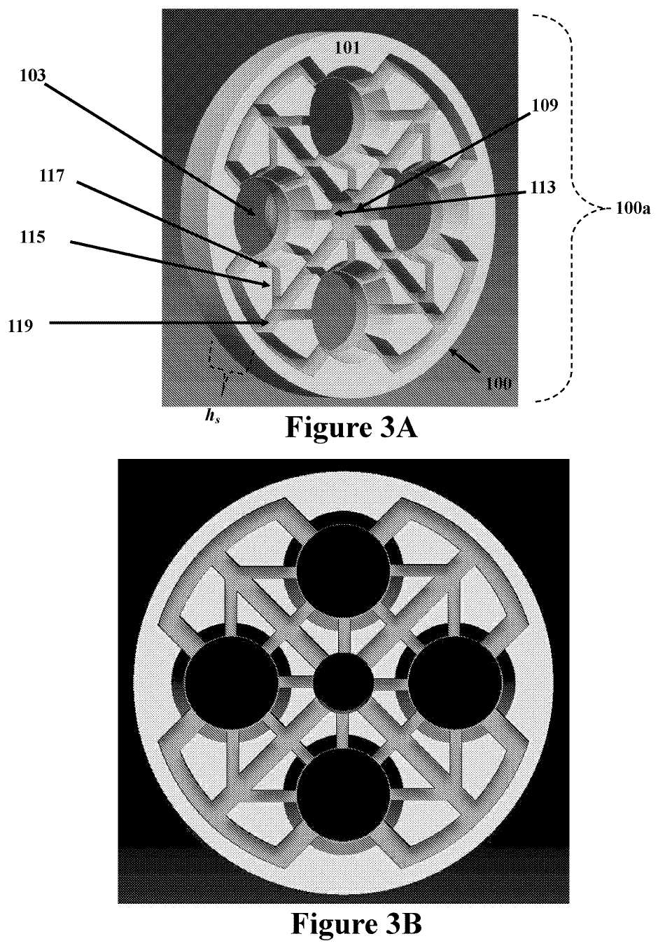

FIG. 3A is a rear perspective view of an HFVN segment 100a (taken along plane A̅B̅ from FIG. 1) showing the interior structure of the HFVN 100. The Manifold 109 is in fluid connection with a Manifold Inlet 113 which, in turn, is in fluid connection with a plurality of Manifold Passages 119. Each Manifold Passage 119 is connected to at least one Manifold Channel 115. Each Manifold Channel 115 is connected to one of the Chokes 103. Thus, gas being passed through the Manifold 109 is able to travel through the Manifold 109, into the Manifold Inlet 113, through a manifold passage 119 down a manifold channel 115 come on and out into the choke 103 through a manifold outlet 117. Thus, there is a continuous fluid connection between the manifold 109 and each of the chokes 103. In this way, a gas may be connected to the Manifold 109 and diffused into a liquid (not shown) which is passing through the Chokes 103. When the Manifold 109 is connected to a gas supply (e.g., air), the small opening of the Manifold Outlets 117 creates a Venturi effect as liquid (e.g., water) flows through the Chokes 103. Given the relatively large diameter of the Chokes 103, a high liquid flow rate can be achieved through the Chokes 103 while, thus, still diffusing gas into the liquid by means of the Venturi effect generated at the Manifold Outlets 117 inside the Chokes 103. For example, if the HFVN 100 is placed inside a pipe (not shown in FIG. 3A), water or another liquid could flow through the pipe and through the HFVN 100.

FIG. 3B is a rear view of an HFVN segment 100a (taken along plane A̅B̅ from FIG. 1) showing the interior structure of the HFVN 100. This figure is included to more clearly show the fluid collections between the Manifold 109, Manifold Inlet 113, Manifold Passages 119, Manifold Channels 115, Manifold Outlets 117 and Chokes 103.

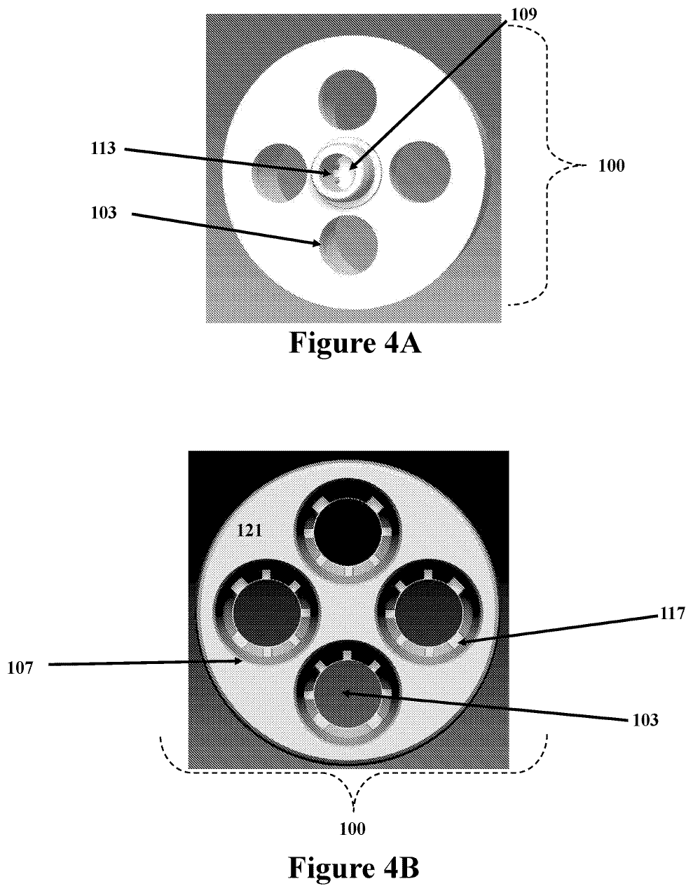

FIG. 4A is a front perspective view of an HFVN 100 having a plurality of Chokes 103 and a single Manifold 109. As can be seen in FIG. 4A, the plurality of Manifold Inlets 113 inside the Manifold 109 has the appearance of “grooves” or “fins.” As discussed earlier herein, each of these Manifold Inlets 113 is fluidly connected to one of the Chokes 103. This allows air or another gas to pass through the Manifold 109 and into the Chokes 103.

FIG. 4B is a rear view of an HFVN 100 having: (a) a plurality of Chokes 103 extending from the Top Surface 102 (not shown in FIG. 4B) to the Bottom Surface 121); and (b) and a single Manifold 109 (not shown in FIG. 4B). As noted elsewhere herein, each Choke 103 includes at least one Manifold Outlet 117 which is fluidly connected to the Manifold 109. Fluid travels from the Choke inlet 105 (not shown in FIG. 4B) through the Choke 103 and exits through the Choke Outlet 107.

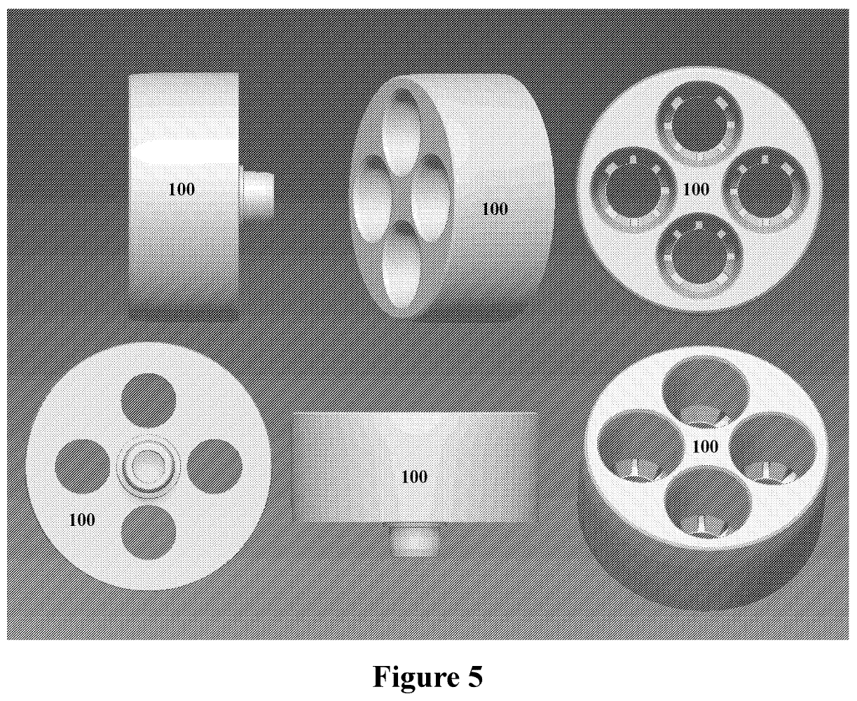

FIG. 5 is a compilation showing several views of an HFVN 100 having a plurality of Chokes 103 (not labeled in FIG. 5) and a single Manifold 109 (not shown in FIG. 5).

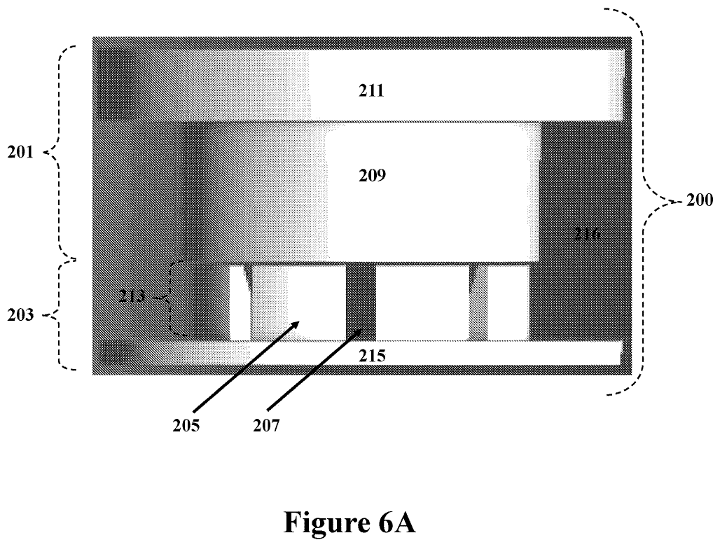

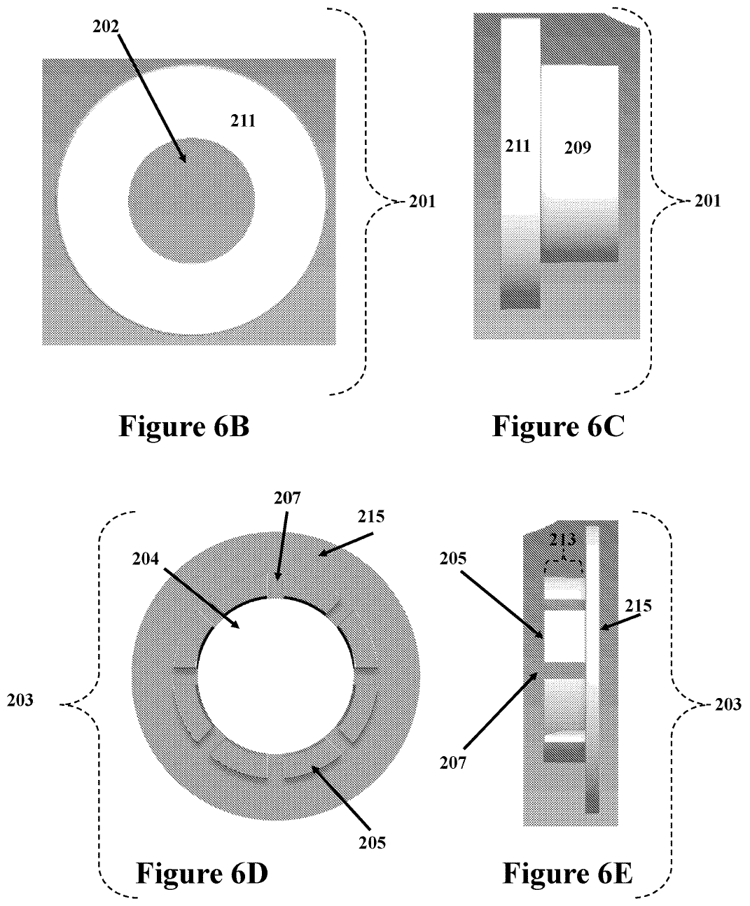

FIG. 6A is a side view of an HFVN Assembly 201 comprising: (a) a Female Cap 201 having a Female Cap Opening 202 (not shown in FIG. 6A); and (b) a Male Cap 203 having a Male Cap Opening 204 (not shown in FIG. 6A). Said Female Cap 201 further comprises a Female Body 209 connected to a Female Flange 211 that extends radially beyond the edges of the Female Body 209. Said Male Cap 203 further comprises a Male Body 213 and a Male Flange 215 that extends radially beyond the edges of the Male Body 213. The Male Body 213 further comprises a series of Fins 205 interspaced with openings (i.e., Manifold Outlets 207). When the Female Cap 201 and the Male Cap 203 are placed together, they define the boundaries of an area of space (i.e., a Pocket 216). Thus, as shown in FIG. 6A, the Pocket 216 is in fluid communion with the Manifold Outlets 207.

FIG. 6B is a front view of a Female Cap 201 of an HFVN Assembly 200. As shown in FIG. 6B, the Female Cap Opening 202 is centrally located in the Female Flange 211 and extends through the width of both the Female Flange 211 and the Female Body 209 (not shown in FIG. 6B).

FIG. 6C is a side vide of a Female Cap 201 of an HFVN Assembly 200 having a Female Body 209 and a Female Flange 211.

FIG. 6D is a front view of a Male Cap 203 of an HFVN Assembly 200. As shown in FIG. 6D, the Male Cap Opening 204 is centrally located in the Male Flange 215 and extends through the width of both the Male Flange 215 and the Male Body 213 (not shown in FIG. 6D).

FIG. 6E is a side vide of a Male Cap 203 of an HFVN Assembly 200 having: (a) a Male Body 213 comprising at least one Fin 205 and at least one Manifold Outlet 207; and (b) a Male Flange 215 extending radially beyond the edges of the Male Body 213.

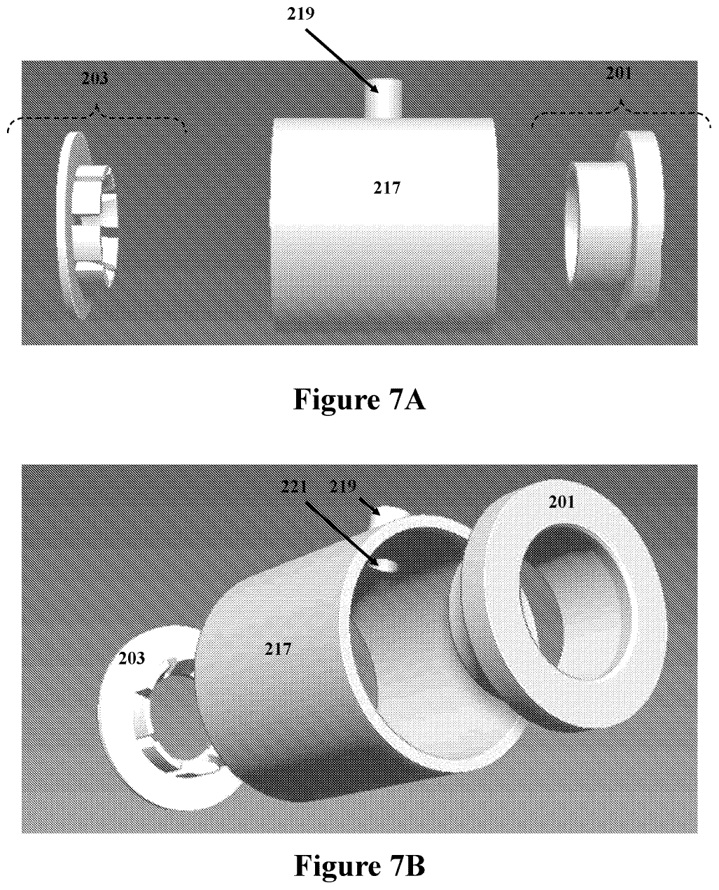

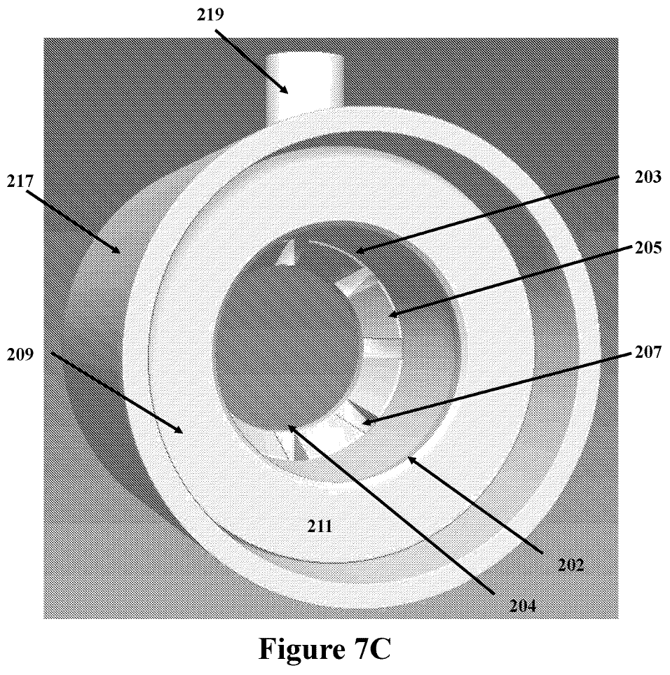

FIGS. 7A and 7B are side and perspective exploded views, respectively, of: (a) an HFVN Assembly 200 comprising a Female Cap 201 and a Male Cap 203 and; (b) a Pipe 217 having a Tee 219 approximately midway along the length of the Pipe 217. The HFVN Assembly 200 is dimensionally sized to securely fit telescopingly inside the Pipe 217 by a friction fit. The Tee 219 is hollow, i.e., having a Tee Opening 221. As shown in FIGS. 7A and 7B, the Pipe 217 having a Tee 219 is commonly referred to as a “reducing tee.” As noted above, the Manifold Outlets 207 are in fluid communion with the Pocket 216. Thus, when the Female Cap 201 is affixed on one end of the Pipe 217 and the Male Cap 203 is affixed on a distal end of the Pipe 217, the Pocket 216 will be in fluid communion with the Tee Opening 221.

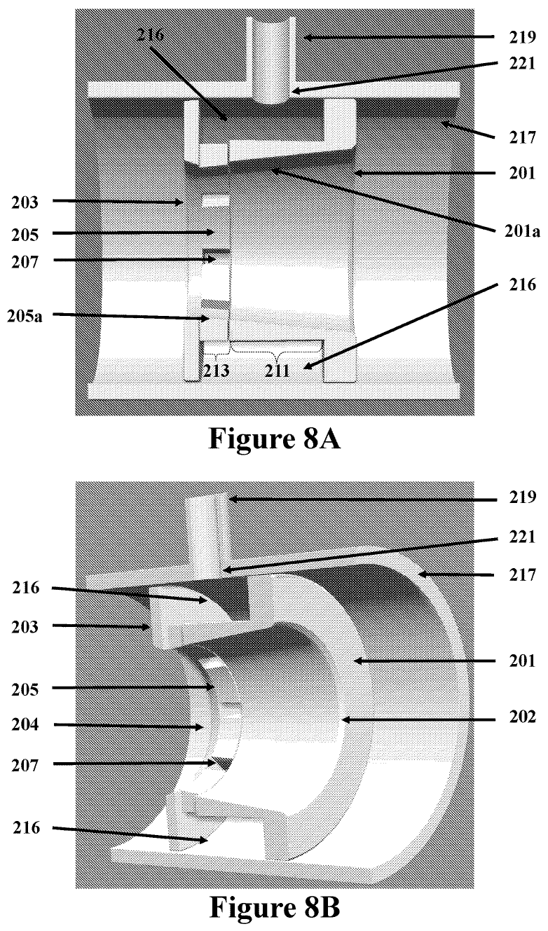

FIG. 7C is a perspective view of an HFVN Assembly 200 attached to a Pipe 217 having a Tee 219. As shown in FIG. 7C, the Female Body 209 is shown fitted inside the Pipe 217. The Female Flange 211 is located entirely inside the Pipe 217. From the perspective view depicted in FIG. 8, the Female Flange 211 of the HFVN Assembly 200 is visible inside of the Pipe 217. Here, the Tee 219 may be connected to a gas supply (e.g., air) and a liquid (e.g., water) passed through the Pipe 217 (and, thus, through the HFVN Assembly 200 through both the Female Cap Opening 202 and the Male Cap Opening 204 which, collectively, form a sort of “choke”). As liquid flows through the HFVN Assembly 200 and the Pipe 217, the Manifold Outlets 117 create a Venturi effect as liquid (e.g., water) flows past the gas (which, in turn, flowed from the Tee Opening 221 into the Pocket 216 and into the Manifold Outlets 207). This embodiment comprises a significant improvement over prior Venturi systems inasmuch as it allows for a relatively high liquid flow rate through the Pipe 217. The perspective view shown in FIG. 7C also illustrates the plurality of Fins 205 and Manifold Outlets 207 present in the Male Cap 203. In particular, the perspective view shown in FIG. 7C shows the pitch or angle associated with the Fins 205 and the Manifold Outlets 207.

FIG. 8A is a side cutaway view of an HFVN Assembly 200 (comprising a Female Cap 201 and a Male Cap 203) attached to a Pipe 217 having a Tee 219. This is a side cutaway view of the same HFVN Assembly 200 and Pipe 217 shown in FIGS. 7A through 7C above. As shown in FIG. 8A, the HFVN Assembly 200 is fully fitted into the Pipe 217 in such a way that the Tee 219 and the Tee Opening 221 are located in-between the Female Flange 211 and the Male Flange 215. This space forms a Pocket 216 defined by the Female Flange 211, the Female Body 209, the Male Body 213 and the Male Flange 215 In the configuration shown in FIG. 8A, the Pocket 216 is in the general shape of a hollow cylindrical segment but could be generally toroidal in other configurations. Thus, there is a fluid connection between the Pocket 216 and the Tee Opening 221 which allows a gas (e.g., air) to be supplied to the Tee 219 and flow into the Picket 216.

The Male Cap 203 has a plurality of Fins 204 and Manifold Outlets 207. These Fins 204 have a Fin Pitch 205a. Each Manifold Outlet 207 is also in fluid communion with the Pocket 216. This allows a liquid (e.g., water) to be passed through the HFVN Assembly 200 while a gas (e.g., air) supplied to the Tee 219, to flow into the Pocket 216 and through each Manifold Outlet 207 where a Venturi effect occurs-thereby causing cavitation of the gas into small bubbles in the liquid-allowing for more ready diffusion of the gas into the liquid.

FIG. 8B is a perspective cutaway view of an HFVN Assembly 200 (comprising a Female Cap 201 and a Male Cap 203) attached to a Pipe 217 having a Tee 219. This is a perspective cutaway view of the same HFVN Assembly 200 and Pipe 217 shown in FIG. SA above (and, thus, also the same as shown in FIGS. 7A through 7C above). As shown in FIG. 8B, the Pocket 216 is in fluid communion with the Tee Opening 221. This allows a gas (e.g., air) to be introduced into the Tee 219 via the Tee Opening 221 which will then flow into the Pocket 216 and out of the plurality of Manifold Outlets 207 defined as the space in-between two adjacent Fins 205. Thus, as a liquid (e.g., water) flows through a first end of the Pipe 217, through the Female Cap Opening 202, through the Male Cap Opening 204 and through a second end of the Pipe 217, it will come in contact with a gas (e.g., air) introduced into the Tee 219 which gas will flow from the Tee Opening 221, through the Pocket 216 and out of the Manifold Outlets 207.

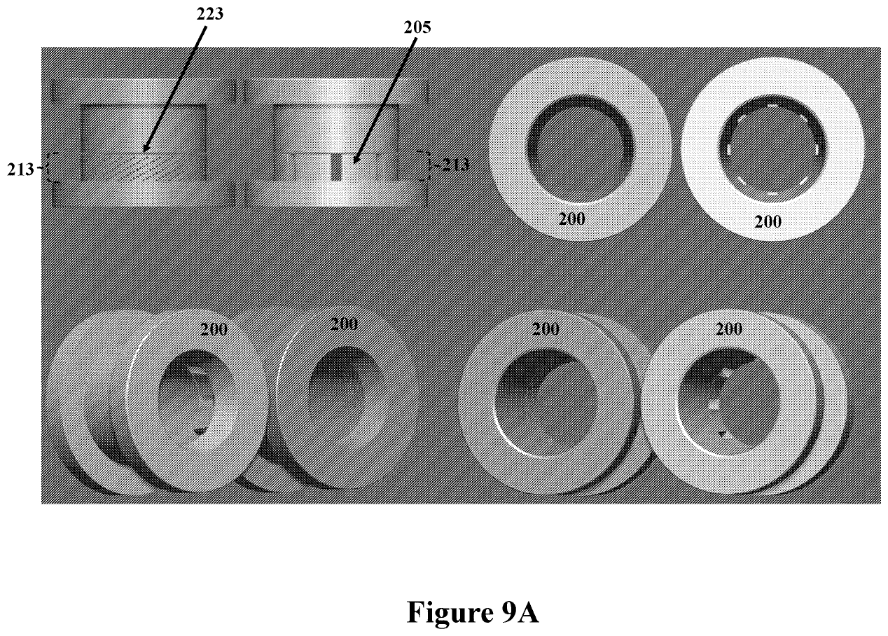

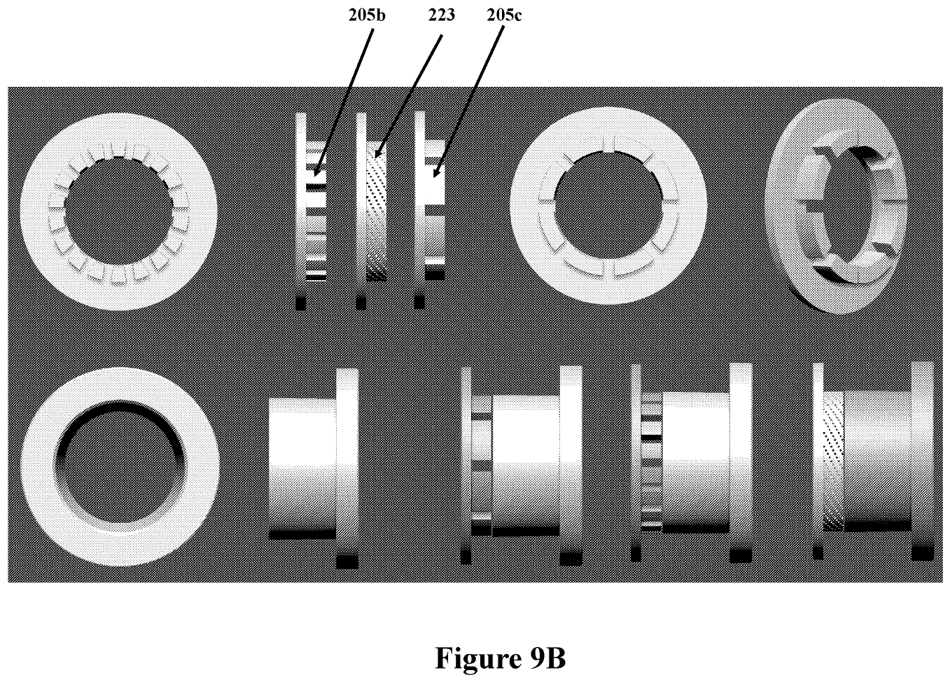

FIG. 9A is a compilation showing several different views of two embodiments of HFVN Assemblies 200, namely: (a) a first embodiment having a plurality of Fins 205 in the Male Body 213 (i.e., the same HFVN Assembly 200 noted in FIGS. 6A through 8B above); and (b) a second embodiment having a plurality of Manifold Outlets 223 in the Male Body 213. These Manifold Outlets 223 are relatively small as compared to the choke and act as miniature Venturis as water or some other fluid passes through the HFVN Assembly 200. A variety of front, back and perspective views of these two HFVN Assembly 200 embodiments are shown in FIG. 9A.

FIG. 9B is a compilation showing several different views of three embodiments of HFVN Assemblies 200, namely: (a) a first embodiment having a plurality of small Fins 205b in the Male Body 213; (b) a second embodiment having a plurality of Manifold Outlets 223 in the Male Body 213; and (c) a third embodiment having a plurality of Large Fins 205c in the Male Body 213. In one embodiment, the HFVN Assembly 200 may be manufactured through the use of three-dimensional printing (“3D Printing”). In particular, the manufacture of the Manifold Outlets 223 in a Male Body 213 are ideal candidates for 3D Printing given the small side of the Manifold Outlets 223.

FIG. 10A is a compilation of different front, side and perspective views of a Top Piece 301 of a Two-Piece HFVN 300 (not labeled in FIG. 10A). The Top Piece 301 has a Top Surface 302 and includes a Manifold 305 and a Manifold Nipple 307 protruding outward from the Top Surface 302. This Manifold 305 is in fluid communion with a hollow Top Chamber 309 located on a reverse side of the Top Piece 301 distal from the Manifold Nipple 307. The Top Piece 301 further includes at least one Top Choke 313a. In the embodiment shown in FIG. 10A, the Top Piece 301 includes a plurality of Top Chokes 313a. Each Top Choke 313a is an orifice which extends through the width of the Top Piece 301 and into the Top Chamber 309. At least one Manifold Outlet 315 is formed into the reverse side of the Top Piece 301 distal from the Manifold Nipple 307. Each Manifold Outlet 315 is connected to a Top Choke 313b.

FIG. 10B is a compilation of different front, side and perspective views of a Bottom Piece 303 of a Two-Piece HFVN 300 (not labeled in FIG. 10B). As shown in FIG. 10B, the Bottom Piece 303 has a Bottom Surface 304 and includes a hollow Bottom Chamber 311. The Bottom Piece 303 also includes at least one Bottom Choke 313b. In the embodiment shown in FIG. 10B, the Bottom Piece 303 includes a plurality of Chokes 313b. Each Bottom Choke 313b is an orifice which extends through the width of the Bottom Piece 303 beyond the Bottom Chamber 311.

FIG. 10C is a compilation of a side and perspective cutaway view of a Two-Piece HFVN 300 (not labeled in FIG. 10C) comprising: (a) a Top Piece 301; and (b) a Bottom Piece 303. As shown in FIG. 10C, the Top Piece 301 (shown to the left of line A̅B̅) and the Bottom Piece 303 (shown to the right of line A̅B̅) detachably join together to form a single Two-Piece HFVN 300. The Top Piece 301 and the Bottom Piece 303 may be permanently joined together by attachment means such as adhesive, PVC cement, ultrasonic welding, welding or brazing depending on the material from which they are constructed. In one embodiment, the Top Piece 301 and the Bottom Piece 303 may be constructed out of plastic using 3D printing technology. As shown in FIG. 10C, the Top Chamber 309 of the Top Piece 301 and the Bottom Chamber 311 of the Bottom Piece 303 are dimensionally sized such that the Top Chamber 309 and the Bottom Chamber 311 are in fluid communion and form a unified compartment when the Top Piece 301 and the Bottom Piece 303 are joined together. The Manifold 305 of the Top Piece 301 is, thus, also in fluid communion with the unified compartment comprised of the Top Chamber 309 and the Bottom Chamber 311. As further shown in FIG. 10C, each Top Choke 313a is aligned with a corresponding Bottom Choke 313b, such that a Top Choke 313a and a Bottom Choke 313b join together to form a unified choke. When a gas (e.g., air or oxygen) is fed into the Manifold 305 and a fluid (e.g., water) passes through the unified choke (comprised of the Top Choke 313a and a Bottom Choke 313b), a Venturi effect occurs within the unified choke at each Manifold Outlet 315. Given the layout and relative size of the unified chokes and compared to the body of the Two-Piece HFVN 300, the apparatus shown in FIGS. 10A-10D has the ability to handle a high flow rate of fluid through the chokes while maintaining a high rate of gas diffusion through the Manifold 305 and into the fluid from the Manifold Outlets 315.

FIG. 10D is a compilation of different side, perspective and rear views of an assembled Two-Piece HFVN 300 showing how the exterior of the Two-Piece HFVN 300 appears when the Top Piece 301 and the Bottom Piece 303 are joined together.

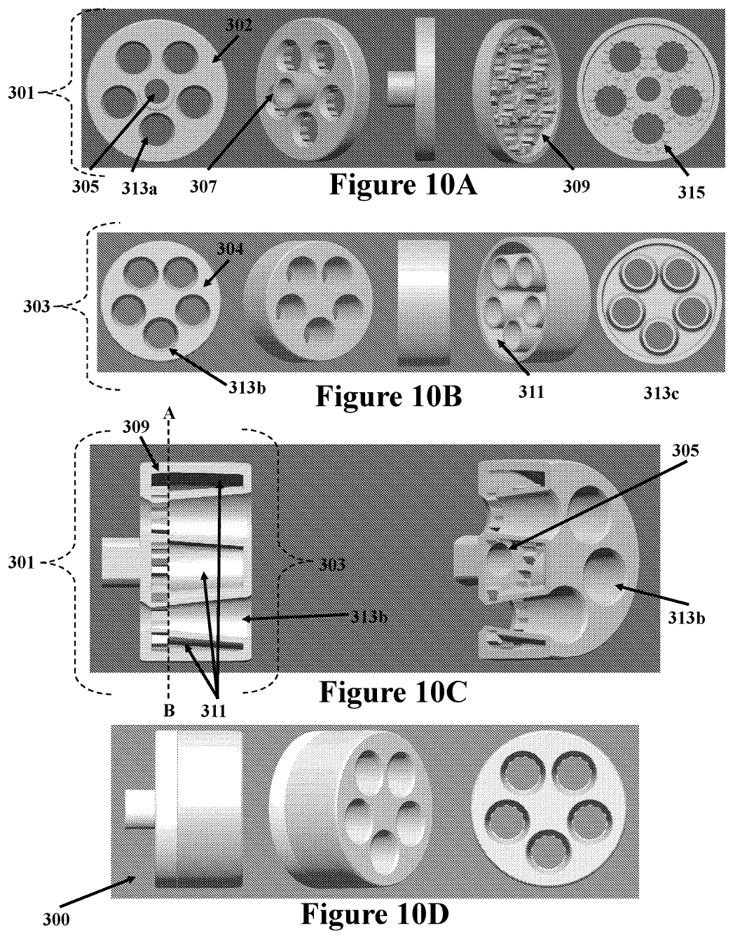

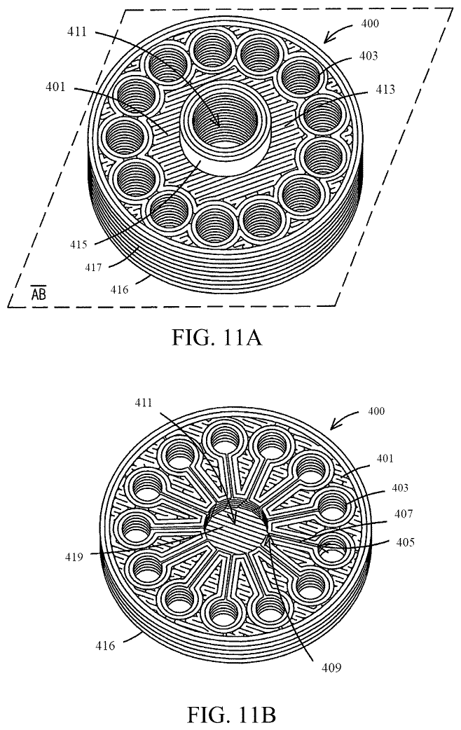

FIG. 11A is a top perspective view of an MVN 400 having at least one Choke 403 and a Manifold 411. In the embodiment shown in FIG. 11A, there are a plurality of Chokes 403. The MVN 400 is then inserted into the end of a pipe or other conduit (not shown in FIG. 11A). The MVN 400 has a body consisting of an impervious Medium 401. In certain embodiments, the Medium 401 could be plastic (including Polyvinyl chloride (“PVC”)), rubber, or metal. The MVN 400 has: (a) a front end having an Outer Surface 413 and a Manifold Nipple 415 which protrudes from the Outer Surface 413 of the MVN 400; and (b) a back end having a Bottom Edge 416. Thus, the Bottom Edge 416 is distal from the Outer Surface 413. The MVN 400 also has a Vertical Surface 417. The Vertical Surface 417 is smooth and uniform. FIG. 11A further shows a plane AB approximately half-way between the Bottom Edge 416 and the Outer Surface 413.

Each Choke 403 is a small opening extending through the body of the MVN 400. Thus, because each Choke 403 is both: (a) more narrow that the diameter of the MVN 400 (and of the pipe or other conduit into which the MVN is inserted) at the Bottom Edge 416; and (b) more narrow than the diameter of the MVN 400 at the Outer Surface 413, each Choke 403 creates a Venturi effect (i.e., a reduction in fluid pressure) between: (a) the distal front and back ends of the MVN 400; and (b) the Choke 403. In one embodiment, the Manifold 411 is generally centrally located within the MVN 400 in order to ensure a uniform distribution of gas or liquid to each of the Chokes 403.

FIG. 11B is a perspective cutaway view of an MVN 400 taken along the plane AB shown in FIG. 11A having a plurality of Chokes 403, a Manifold 411, a body consisting of an impervious Medium 401 and a Bottom Edge 416. The Manifold 411 is a cavity and has a Manifold Nipple 415 (not shown in FIG. 11B) and terminates in a Manifold Back 419 distal from the Manifold Nipple 415. The Manifold 411 has at least one Manifold Inlet 409 connected to a Manifold Channel 407. In the embodiment shown in FIGS. 11A and 11B, the MVN 400 has a plurality of Manifold Inlets 409. The Manifold Channel 407 has a Manifold Outlet 405 distal from the Manifold Inlet 409. The Manifold Inlet 409 is connected to a Choke 403. Thus, gas or liquid is allowed to freely pass from the Manifold 411 through the Manifold Inlet 409 through the Manifold Channel 407 through the Manifold Outlet 405 and into the Choke 403. A hose, tube, pipe or other piping (not shown in FIG. 11A) dimensionally sized to mate with the Manifold Nipple 415 is used to connect the Manifold 411 to a first gas or a liquid. The gas or liquid could be pressurized or could be at standard atmospheric pressure. The first gas or liquid could be any number of substances depending on the application for which the MVN is being used. A second gas or liquid is passed through the pipe or other conduit which then flows through the Chokes 403.

Common first gasses/liquids and their corresponding applications include:

| Gas(es) / Liquids | MVN Application |
|---|---|
| Air or Oxygen Gas | Aeration, oxygenation and |
| | atomization (e.g., |
| | dispersing perfume or |
| | spray paint) |
| Ozone | Ozonation of a liquid; |
| | ozonating water; ozonating |
| | blood |
| Carbon Dioxide Gas | Carbonating a liquid |
| Fluorine Gas | Fluorinating a liquid; water |
| | fluoridation |
| Chlorine Gas | Chlorinating a liquid; |
| | water chlorination |
| Flammable Gas | Inspirating air |
| Fuel (e.g., Gasoline or Diesel) | Carburetor |

Thus, when a first gas or liquid is connected to the Manifold 411 and a second gas or liquid is connected to the MVN 400 and passes through the Choke 403, the Venturi effect caused within the Choke 403 will cause the first gas or liquid and the second gas or liquid to mix together.

The MVN 400 shown in FIGS. 11A and 11B is made using a three-dimensional (“3D”) printer. Thus, the Medium 401 is shown as consisting of “rows” of material as is common for 3D printed articles. 3D printing the MVN 400 allows for the MVN 400 to be precision constructed; particularly with respect to the various Manifold Inlets 409, Manifold Channels 407 and Manifold Outlets 405 (depending on the size of which traditional casting/drilling methods could prove cost prohibitive or impossible).

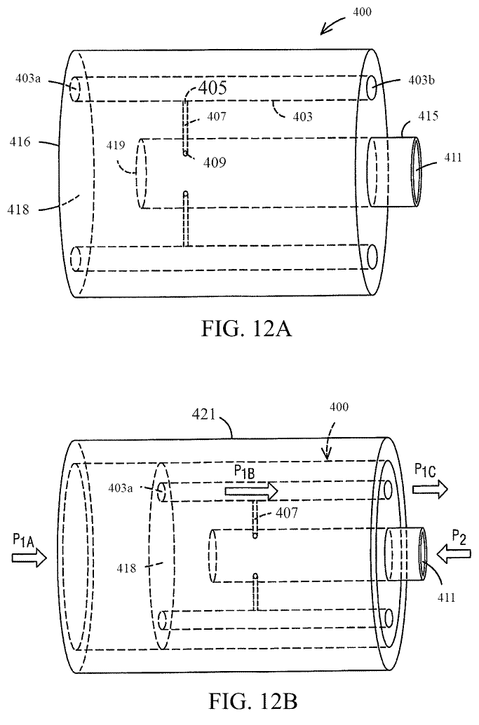

FIG. 12A is a stylized side view of a MVN 400 having at least one Choke 403, each Choke 403 having a Choke Inlet 403a and a Choke Outlet 403b. The MVN 400 also has a Manifold 411 having a Manifold Nipple 415 and a distal Manifold Back 419. The Manifold 411 is connected to the Choke 403 by a Manifold Channel 407, each Manifold Channel 407 having a Manifold Inlet 409 and a Manifold Outlet 405. The MVN 400 further has a Bottom Surface 418 with a Bottom Edge 416 distal from the Manifold Nipple 415.

FIG. 12B is a stylized side view of an MVN 400 which has been inserted into a Pipe 421. In the embodiment shown in FIG. 12B, a fluid (such as water) is passed through the Pipe 421 at an Initial Pressure of P_{1A}. As this fluid encounters the Choke Inlets 403a, the fluid undergoes a Venturi effect, resulting in a changed static fluid pressure within the Choke 403, i.e., the Choke Pressure of P_{1B}. In the embodiment shown in FIG. 12B, a gas (such as air) is passed through the Manifold 411 at a Second Pressure of P₂. Thus, the gas is drawn through each Manifold Channel 407 and mixes with the fluid in the Chokes 403. The gas/fluid mixture then exits the Chokes 403 through their Choke Outlets 403b at a Final Pressure P_{1C}.

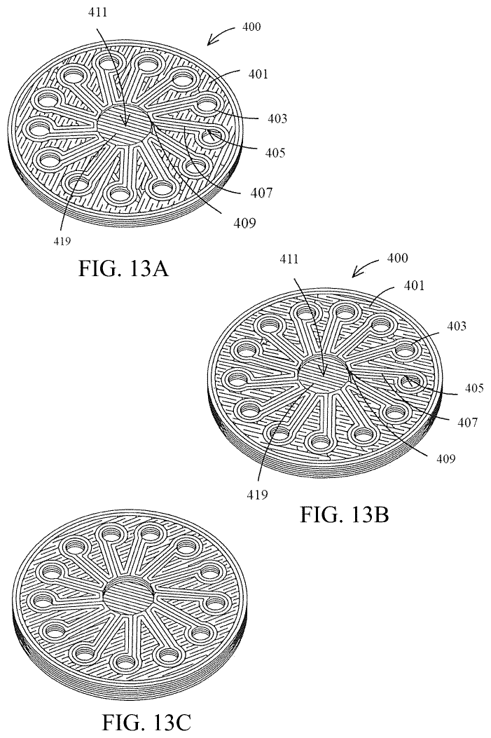

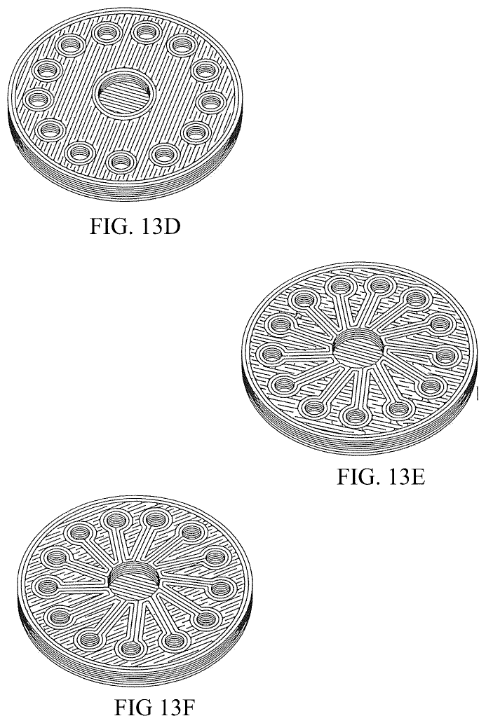

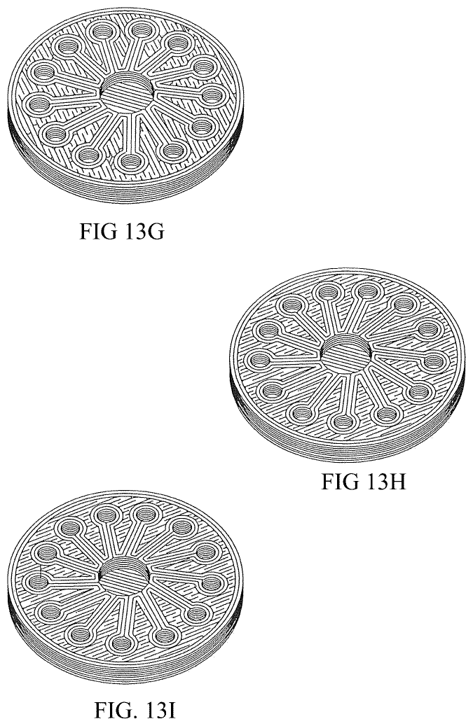

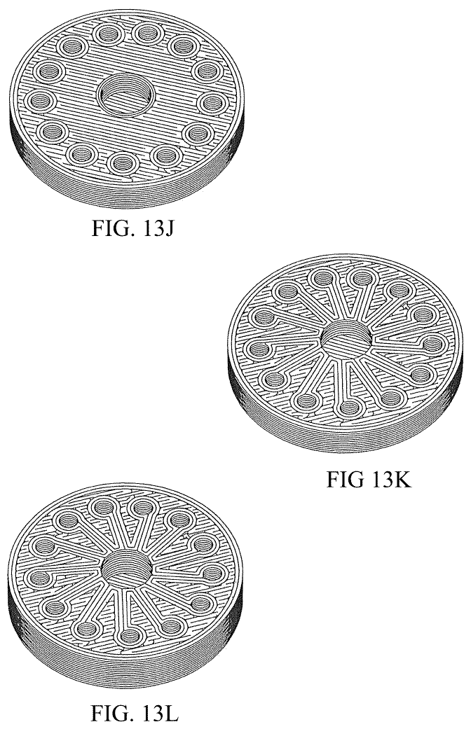

FIGS. 13A through 13L depict sequential perspective views of the process of manufacturing a MVN 400 using 3D printing. As can be seen in FIG. 13A, a MVN 400 is at an early stage of 3D printing with only the initial “layers” of Medium 401 having been 3D printed. The MVN 400 has the beginnings of a centrally located Manifold 411 with a Manifold Back 419 and a plurality of Manifold Inlets 409, each of which is connected to a Manifold Channel 407 with a Manifold Outlet 405 distal from the Manifold Inlet 409. Each Manifold Outlet 405 is connected to a Choke 403.

FIG. 13B shows the same MVN 400 from FIG. 13A with several additional “layers” of Medium 401 having been 3D printed. As can be seen in FIG. 13B, the central Manifold 411 and each of the Chokes 403 has been further formed in the same positions. However, each of the Manifold Outlets 405, Manifold Channels 407 and Manifold Inlets 409 from FIG. 13A have been fully formed and “capped off,” while new Manifold Outlets 405, Manifold Channels 407 and Manifold Inlets 409 have been partially formed which are “rotated” with respect to an axis defined by the Manifold 411. This rotational process is cyclically repeated throughout the 3D layering process as shown in the remaining FIGS. 13C through 13L. In particular, FIG. 13D shows a “capping” layer in which all of the Manifold Outlets 405, Manifold Channels 407 and Manifold Inlets 409 in a particular layer have been “capped”. Thus, in the embodiment shown in FIGS. 13A through 13L, the plurality of Manifold Outlets 405, Manifold Channels 407 and Manifold Inlets 409 form a generally helical structure.

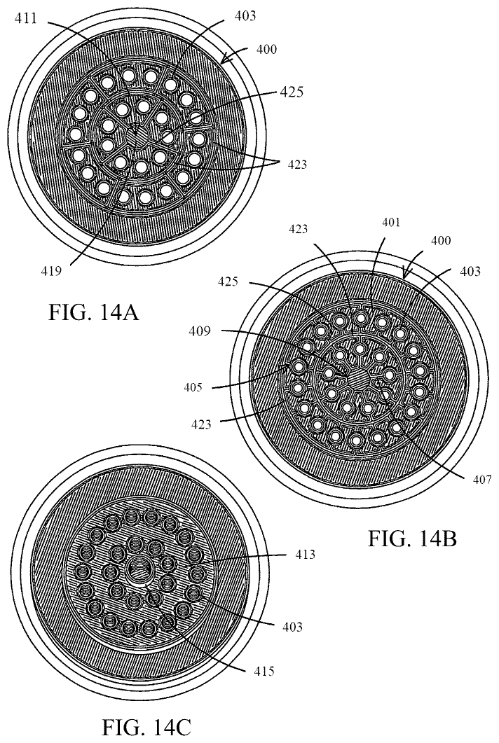

FIG. 14A through FIG. 14C depict sequential perspective views of the process of manufacturing an alternative embodiment of an MVN 400 using 3D printing. In FIG. 14A, an MVN 400 is shown having a plurality of Chokes 403 which are located in two concentric groupings about a central Manifold 411 (which Manifold 411 has a Manifold Back 419). The Chokes 403 are connected to the Manifold 411 by a system of concentric Manifold Rings 423 and radial Manifold Passages 425. The innermost Manifold Ring 425 is connected to the Manifold 411 by at least one Manifold Passage 425. The outermost Manifold Ring 423 is connected to the innermost Manifold Ring 423 by at least one Manifold Passage 425.

In FIG. 14B, the same MVN 400 is shown from FIG. 14A after several additional layers of Medium 401 have been 3D printed. In FIG. 14B, the same structure of Manifold Inlets 409, Manifold Channels 407 and Manifold Outlets 405 as previously disclosed herein may be seen connecting each Choke 403 to a nearby Manifold Ring 423. In the design shown in FIG. 14B, however, each Choke 403 has two Manifold Outlets 405 since the Manifold Channels 407 are used to help further connect the Manifold Rings 423 to the Manifold 411.

FIG. 14C shows the MVN 400 from FIGS. 14A and 14B after the final layers of Medium 401 have been applied thereto. As can be seen in FIG. 14C, the MVN 400 has a plurality of finished Chokes 403 and an Outer Surface 413 with a Manifold Nipple 415 extending outwards from such Outer Surface 413. The Manifold Nipple 415 shown in FIG. 14C is a “male” attachment means. However, “female” attachment means such as an interior hole dimensionally sized to accommodate a pipe or tube could also be used.

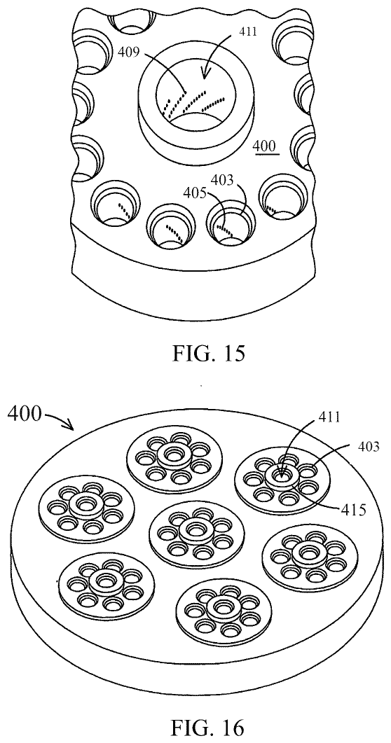

FIG. 15 is an enlargement of a MVN 400 showing enlarged details of a finished Choke 403 and Manifold 411. As can be seen in this enlarged detail, within the Choke 403 there are a plurality of helically distributed Manifold Outlets 405. As can also be seen in this enlarged detail, within the Manifold 411 there are a plurality of helically distributed Manifold Inlets 409. A method of constructing an MVN 400 resulting in such helically distributed Manifold Outlets 405 and Manifold Inlets 409 is described above in FIGS. 13A through 13L.

FIG. 16 shows a top perspective view of a MVN 400 having a plurality of Manifolds 411 each having a Manifold Nipple 415 and a plurality of Chokes 403. In essence, this is like having a plurality of MVNs 400 surrounded by Medium 401. As noted above, each of the Manifolds 411 could be connected to a single gas or liquid source or be connected to separate gas or liquid sources allowing the MVN 400 to effectively “mix” and simultaneously dissolve different compounds into the primary gas or liquid.

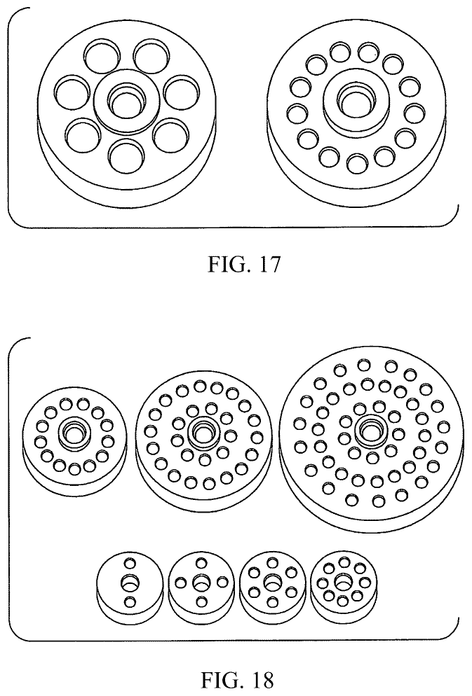

FIG. 17 shows top perspective views of two MVNs 400 having differently sized Chokes 403. The size of the Choke 403 can be adjusted based on the desired flow of fluid or gas through the Chokes 403 and the desired ratio of mixing the two fluids or gases together within the Chokes 403.

FIG. 18 shows top perspective views of seven different sizes of MVNs 400 each having a different number/distribution pattern of Chokes 403. As can be seen in FIG. 18, the four leftmost MVNs 400 do not have a Manifold Nipple 415 but instead simply have an opening in the Manifold 411 which is flush with the Outer Surface 413. This creates a “female” opening for inserting a pipe or a hose into the Manifold 411. In certain embodiments, threading could be used in either such a “female” opening or in a Manifold Nipple 415 to further engage the Manifold 411 to a pipe or hose.

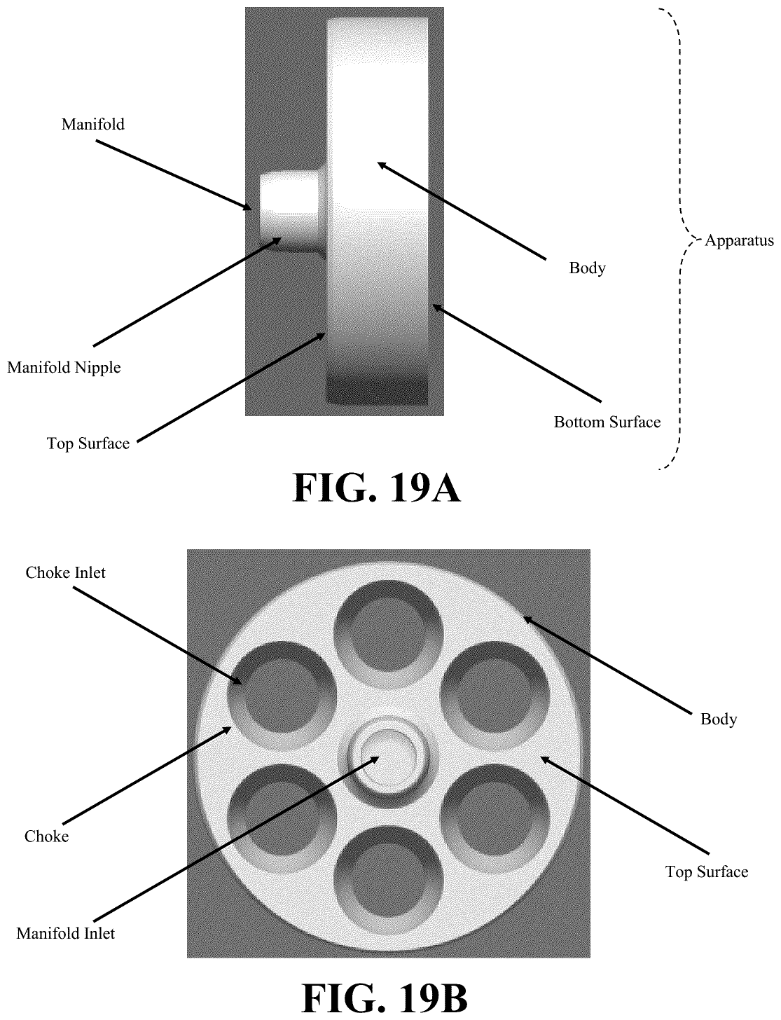

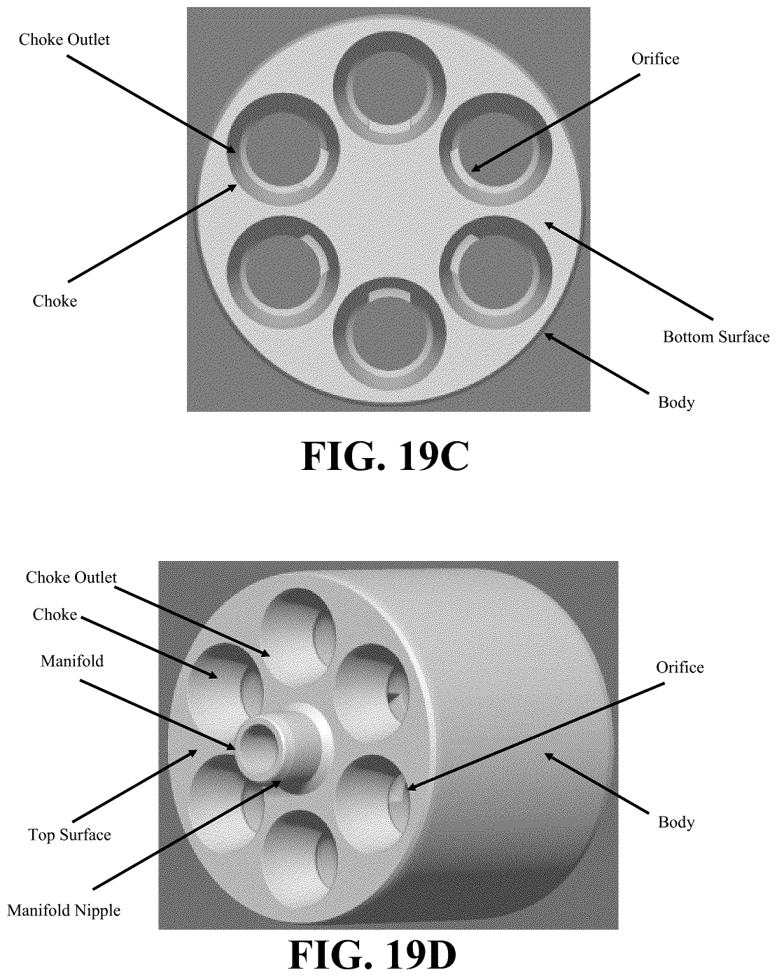

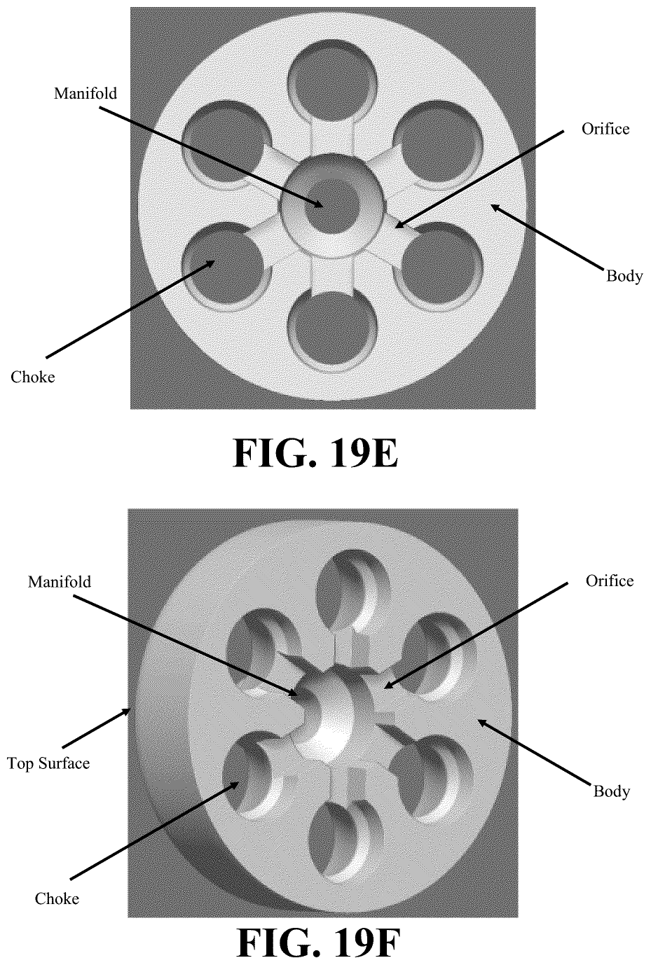

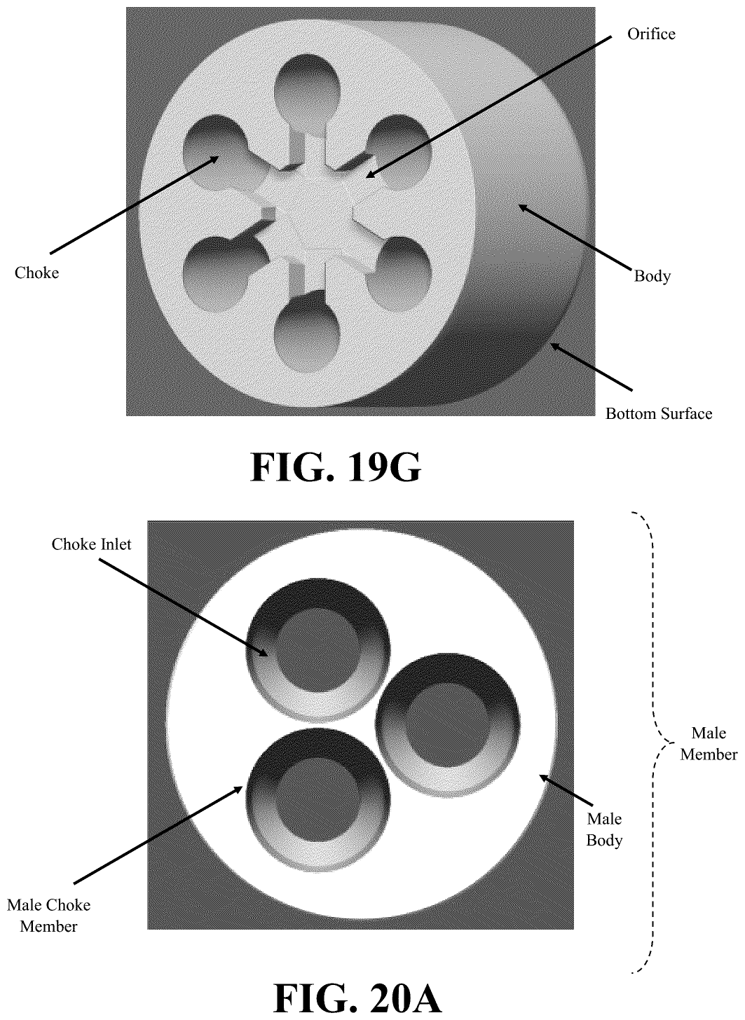

FIGS. 19A through 19G show an embodiment of an Apparatus having a Manifold and at least one Choke. In the embodiment shown in FIGS. 19A through 19G, the Apparatus has a plurality of Chokes, with each Choke connected to the Manifold by at least one Orifice. In other embodiments, however, the Apparatus could have only a single Choke. In the embodiment shown in FIGS. 19A through 19G, the Apparatus has a Body which may be formed of a variety of materials such as plastic, PVC or metal. z The Body has a Top Surface and a distal Bottom Surface, with each Choke extending from the Top Surface through the Bottom Surface. In the embodiment shown in FIGS. 19A through 19G, each Choke has a Choke Inlet at the Top Surface and a Choke Outlet at the Bottom Surface. In the embodiment shown in FIGS. 19A through 19G, each Choke has only one Orifice which connects the Choke to the Manifold. However, in alternative embodiments, two or more Orifices could connect each Choke to the Manifold. In the embodiment shown in FIGS. 19A through 19G, a Manifold Nipple protrudes from the Body and may be dimensionally sized to accommodate a variety of tubing or hoses which, in turn, may be connected to a gas supply such as an air supply. In certain embodiments, this gas supply could simply be an air vent to the atmosphere. In other embodiments, the Manifold could be connected to a gas supply through a threaded tube or other means of providing a connection to a gas supply. Thus, when: (a) the Manifold is connected to an external gas supply; and (b) a fluid is passed through the Chokes; the gas can travel through the manifold and out of the Orifice into each Choke. A venturi effect will then occur within each Choke at each Orifice as the gas is diffused into the liquid. For example, a venturi effect can be achieved by connecting the Manifold to an air supply and passing water through the chokes. The gas will travel from the Manifold, through each Orifice and into each Choke where it will encounter the flowing water. A venturi effect will then occur within the Choke and aeration will occur at the Orifice. In the embodiment shown in FIGS. 19A through 19G, the Apparatus can be placed into a pipe (not shown) through which the fluid is flowing.

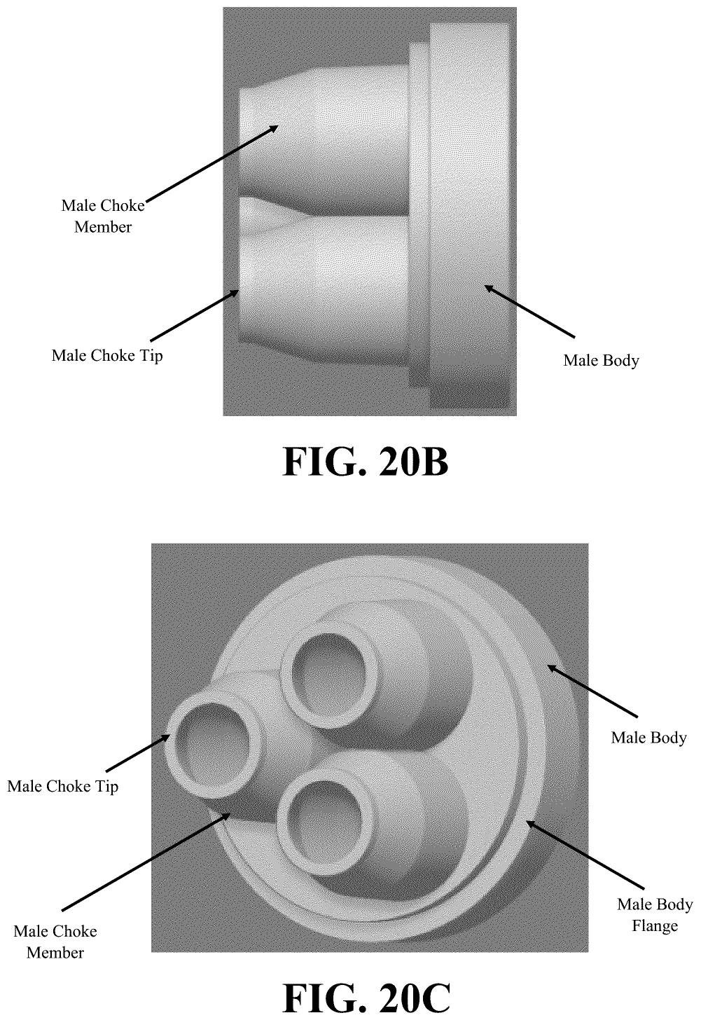

FIGS. 20A through 22D show an embodiment of an Apparatus comprising a Male Member and a Female Member.

FIGS. 20A through 20C show an embodiment of a Male Member of an Apparatus having a Male Body and a plurality of Male Choke Members. In alternative embodiments, the Male Body could have only a single Male Choke Member. In the embodiment shown in FIGS. 20A through 20C, the Male Body has a Choke Inlet and a distal Male Choke Tip. In certain embodiments, the Male Body can also have a Male Body Flange. In certain embodiments, each Male Choke Member has a generally cylindrical portion, a generally conical portion, and a Male Choke Tip.

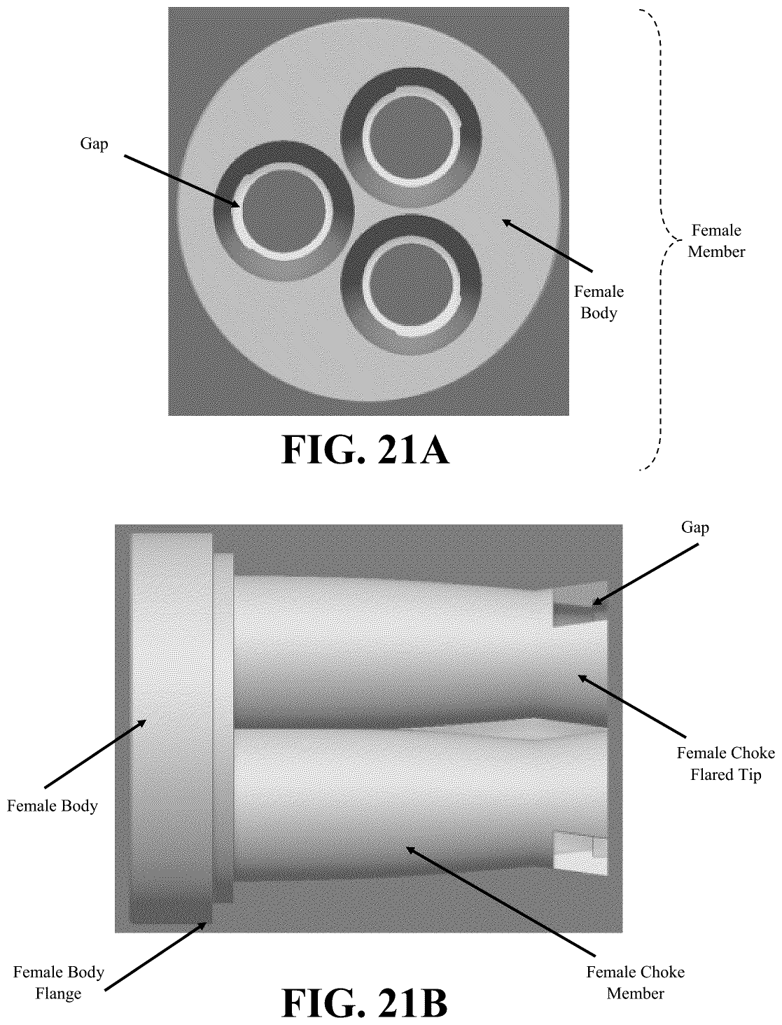

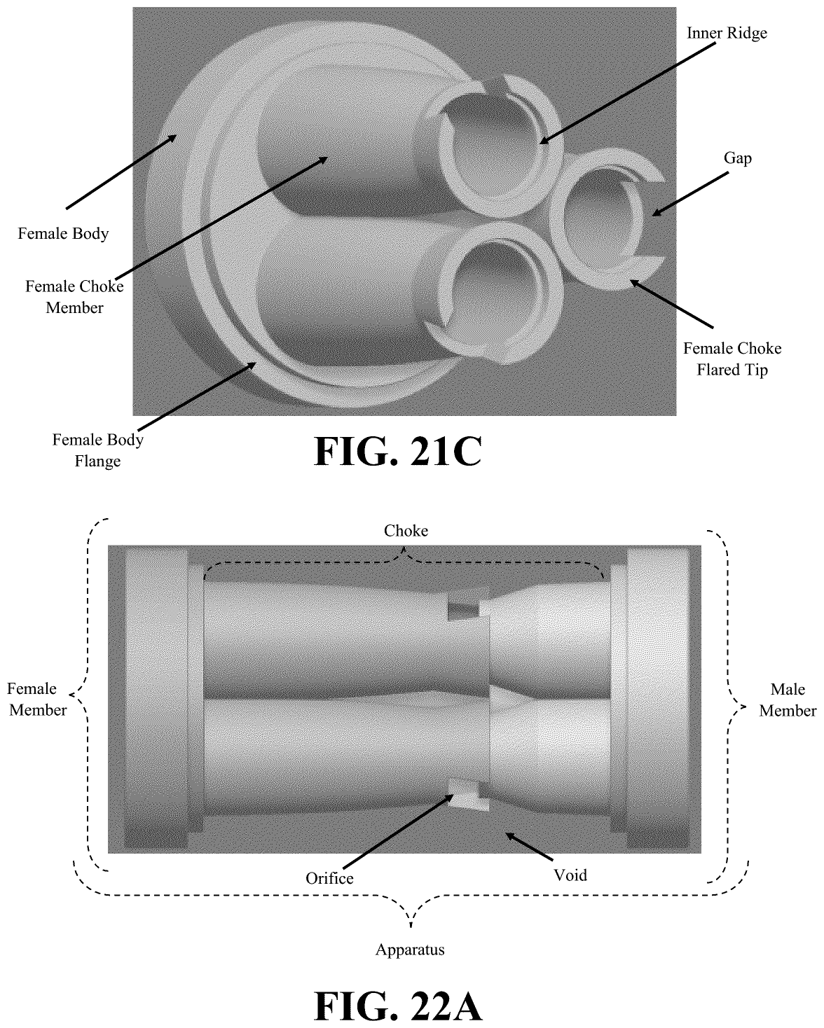

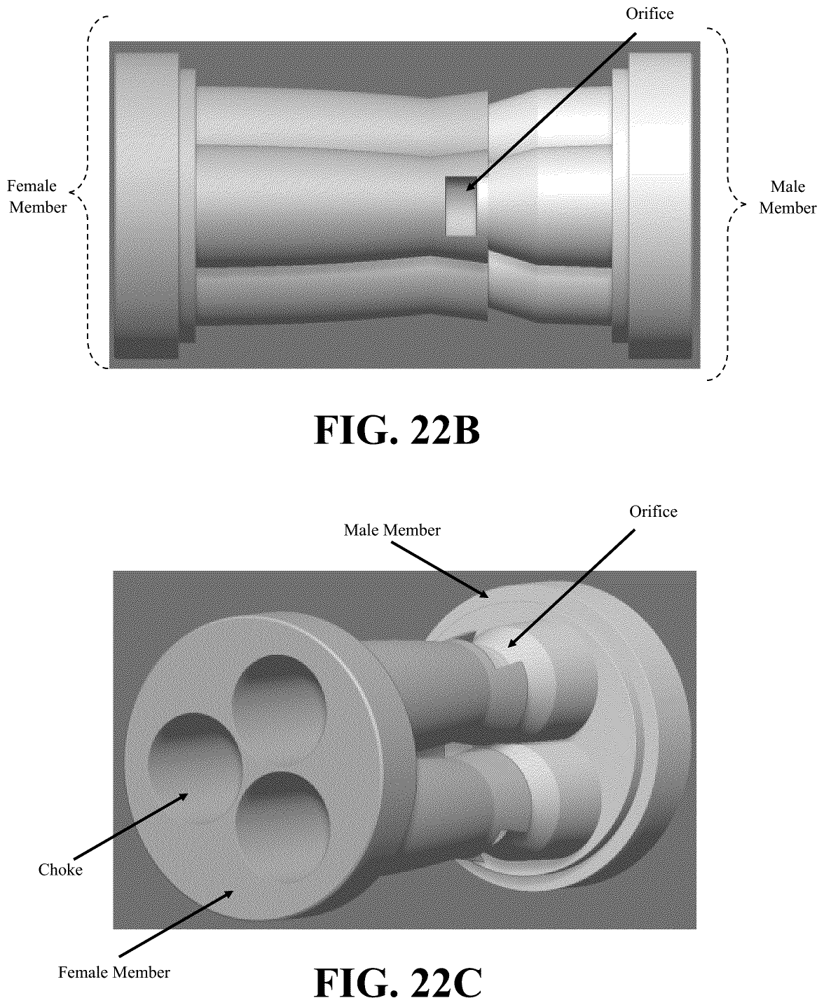

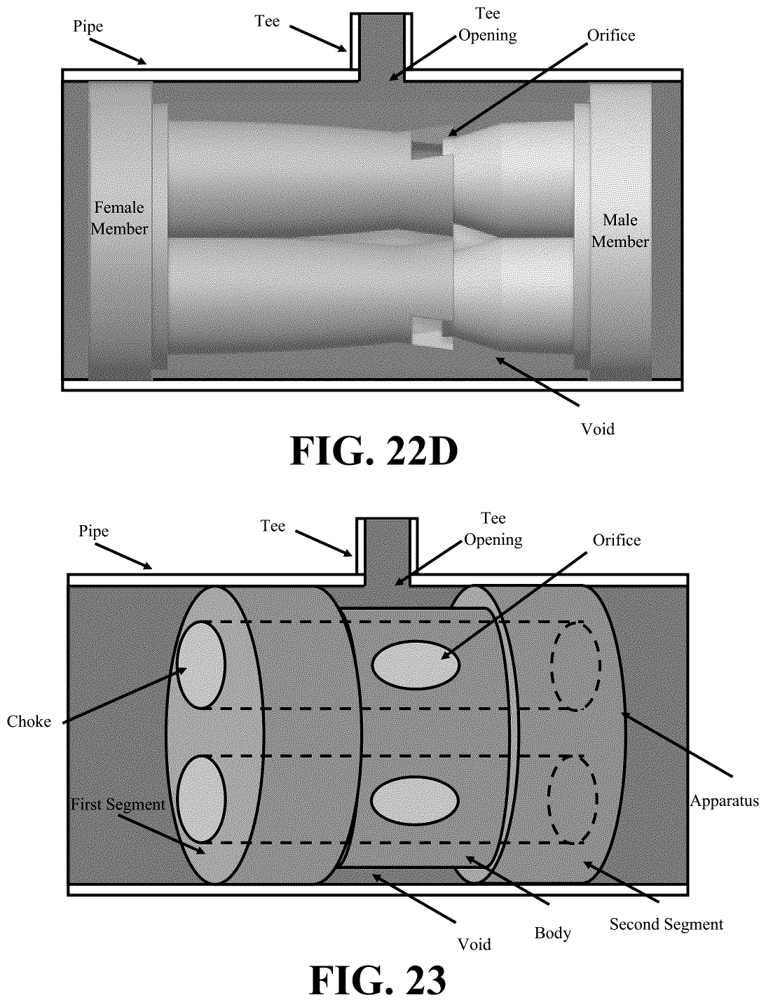

FIGS. 21A through 21C show an embodiment of a Female Member of an Apparatus having a plurality of Chokes. In alternative embodiments, the Female Member could have only a single Female Choke Member. In certain embodiments, each Female Choke Member is dimensionally sized to accommodate a corresponding Male Choke Member. In certain embodiments, this engagement could be an abutment of the Male Choke Member adjacent to the Female Choke Member. In other embodiments (such as those shown in FIGS. 20A through 22D) this could be a telescoping engagement (i.e., a mating engagement of the Male Choke Member to the Female Choke Member). This telescoping engagement is aided by a Female Choke Flared Tip at one end of each Female Choke Member, said Female Choke Flared Tip dimensionally sided to mate with a Male Choke Tip. In alternative embodiments, this could be other types of engagement (e.g., a thread and screw engagement or a press-fit engagement). Each Female Choke Member and corresponding Male Choke Member together comprise a Choke. Each Choke has at least one orifice. In the embodiment shown in FIGS. 20A through 22D, the Orifice is comprised of a Gap in the Female Choke Member. In alternative embodiments, the Orifice could be either a similar Gap in the Male Choke Member, or an opening in either the Female Choke Member or the Male Choke Member. The Orifice is in fluid communication with a Void. When the Apparatus is placed inside a Pipe (with said Pipe having a Tee) as shown in FIG. 22D, the Void is in fluid communication with the Tee Opening. Thus, a gas supply (not shown) can be connected to the Tee which will then flow into the Void and the Orifice. When a fluid is passed through the Choke, a venturi effect will occur within the Choke and diffusion of the gas will occur at the Orifice. For example, if the Tee is connected to an air supply, and water is passed through the Pipe, the water will flow through each Choke, will have a venturi effect within the choke, and aeration will occur at the Orifice.

FIG. 23 shows a stylized drawing of a side view of an embodiment of an Apparatus within a cutaway Pipe having a Tee. In the embodiment shown in FIG. 23, the Apparatus comprises a Body having at least one Choke. The body has a First Segment at one end of the Body and a Second Segment at a distal end of the Body. The First Segment and the Second Segment protrude from the Body. In the embodiment shown in FIG. 23, the First and Second Segments are generally cylindrical in shape, but could be other shapes (e.g., conical, hourglass, etc.) in other embodiments. In the embodiment shown in FIG. 23, two Chokes are shown, but in alternative embodiments, there could be either a single Choke or a plurality of Chokes. Each Choke extends through the length of the Body and has at least one Orifice which is in fluid communion with a Void space defined by the walls of the Pipe and the First and Second Segments. The Void is in fluid communication with the Tee Opening. Thus, a gas supply (not shown) can be connected to the Tee which will then flow into the Void and the Orifice. When a fluid is passed through the Choke, a venturi effect will occur within the Choke and diffusion of the gas will occur at the Orifice. For example, if the Tee is connected to an air supply, and water is passed through the Pipe, the water will flow through each Choke, will have a venturi effect within the choke, and aeration will occur at the Orifice.

It is to be understood that while a preferred embodiment of the invention is illustrated, it is not to be limited to the specific form or arrangement of parts herein described and shown. It was be apparent to those skilled in the art that various changes may be made without departing from the scope of the invention and the invention is not to be considered limited to what is shown and described in the specification and drawings.

1. A High Flow Venturi Nozzle comprising:
(a) a body having a top surface and a distal, bottom surface;
(b) at least one generally cylindrical choke extending through the body from the top surface to the bottom surface; each choke having a choke inlet through the top surface and a choke outlet through the bottom surface;
(c) a manifold extending from the top surface into the body and terminating within the body; and
(d) a connection between each choke and the manifold.

2. The High Flow Venturi Nozzle of claim 1 further comprising:
a plurality of chokes.

3. The High Flow Venturi Nozzle of claim 1 further comprising:
(a) the body being generally cylindrical in shape and dimensionally sized to telescopingly engage within a pipe;
(b) at least four chokes, each of which are located equidistant from one another;
(c) the manifold being centrally located with respect to the top surface; said manifold having a manifold nipple extending outwardly from the top surface;
(d) said connection between each choke and the manifold comprising:
(i) at least one manifold channel having a manifold inlet and a manifold outlet; said manifold inlet connected to the manifold and said manifold outlet connected to a choke; and
(ii) at least one manifold channel having a manifold inlet and a manifold outlet; said manifold inlet connected to a manifold passage and said manifold outlet connected to a choke; said manifold passage connected to the manifold.

4. The High Flow Venturi Nozzle of claim 1 further comprising:
(a) the body further comprising:
(i) a top piece having a top chamber; and
(ii) a bottom piece;
the top surface being on the top piece and the bottom surface being on the bottom piece;
(b) each choke further comprising:
(i) a top choke which extends through the top piece; and
(ii) a bottom choke which extends through the bottom piece; and
(c) the manifold extending from the top surface into the body and terminating within the top chamber.

5. The High Flow Venturi Nozzle of claim 4 further comprising:
the bottom piece having a bottom chamber.

6. The High Flow Venturi Nozzle of claim 4 further comprising:
the connection between each choke and the manifold comprising a plurality of manifold outlets.

7. A High Flow Venturi Nozzle assembly comprising:
(a) a female cap having:
(i) a female body;
(ii) a female flange; and
(iii) a female cap opening extending through the female flange and through the female body;
(b) a male cap having:
(i) a male body;
(ii) a male flange;
(iii) a male cap opening extending through the male flange and through the male body; and
(iv) at least one orifice in the male body; and
(c) a pocket defined by the female cap and the male cap when the female cap and male cap are joined together.

8. The High Flow Venturi Nozzle assembly of claim 7 further comprising:
the at least one orifice comprising a plurality of manifold outlets; the male body comprising a plurality of fins each having a fin pitch.

9. The High Flow Venturi Nozzle assembly of claim 7 further comprising:
the High Flow Venturi Nozzle assembly dimensionally sized to telescopingly fit inside a pipe; the pipe having a tee with a tee opening which is in fluid communion with the pocket.

10. The High Flow Venturi Nozzle assembly of claim 7 further comprising:
the at least one orifice comprising a plurality of small fins each having a fin pitch;

11. The High Flow Venturi Nozzle assembly of claim 7 further comprising:
the at least one orifice comprising a plurality of large fins each having a fin pitch;

12. The High Flow Venturi Nozzle assembly of claim 7 further comprising:
the at least one orifice comprising a plurality of manifold outlets;

13. The High Flow Venturi Nozzle assembly of claim 12 further comprising:
the plurality of manifold outlets arranged in a helical distribution;

14. A method of using a High Flow Venturi Nozzle having a manifold and at least one choke comprising:
(a) step one: placing the High Flow Venturi Nozzle in a pipe;
(b) step two: connecting a gas supply to the manifold of the High Flow Venturi Nozzle; and
(c) step three: passing a liquid through the at least one choke to cause a Venturi effect therein.

15. A multiple-Venturi nozzle comprising:
(a) a generally cylindrical body having a generally flat bottom surface and a generally flat distal outer surface and a generally arcuate vertical surface parallel to the bottom and outer surfaces;
(b) a plurality of chokes generally perpendicular to the bottom and outer surfaces, each of said chokes extending through the body and having a choke inlet and a choke outlet;
(c) a manifold extending from the outer surface partially into the body; and
(d) a plurality of manifold channels connecting the manifold to each choke, each of said manifold channels:
(i) being generally perpendicular to a corresponding choke; and
(ii) having a manifold outlet and a distal manifold inlet.

16. The multiple-Venturi nozzle of claim 15 further comprising:
said multiple-Venturi nozzle being constructed by means of:
(i) 3D printing said multiple-Venturi nozzle in layers of a 3D printing material; and
(ii) each manifold channel which corresponds to a given choke being offset from one another by the thickness of at least one 3D printed layer of material.

17. The multiple-Venturi nozzle of claim 15 further comprising:
said manifold being generally central with respect to the body; and said manifold having a manifold nipple.

18. The multiple-Venturi nozzle of claim 17 further comprising:
each of said chokes are evenly distributed radially about an axis defined by the manifold.

19. The multiple-Venturi nozzle of claim 17 further comprising:
(e) a first manifold ring;
(f) at least one additional, concentric manifold ring;
(g) at least one manifold channel connecting the manifold to the first manifold ring;
(h) at least one manifold channel connecting the additional manifold ring to the first manifold ring; and
(i) additional chokes connected to the manifold rings by additional manifold channels.

20. The multiple-Venturi nozzle of claim 17 further comprising:
each of said additional chokes are evenly distributed radially about an axis defined by the manifold in concentric groupings.

21. The multiple-Venturi nozzle of claim 20 further comprising:
a fluid being passed through the chokes; and
a gas source connected to the manifold.

22. The multiple-Venturi nozzle of claim 15 further comprising:
a plurality of manifolds extending from the outer surface partially into the body and being associated with its own respective chokes; and
a plurality of manifold channels connecting each such manifold to its own respective chokes, each of said manifold channels:
(i) being generally perpendicular to a corresponding choke;
(ii) having a manifold outlet and a distal manifold inlet; and
(iii) being offset in a helical distribution from other manifold outlets corresponding to the same choke.

23. The multiple-Venturi nozzle of claim 22 further comprising:
a fluid being passed through the chokes;
a first manifold connected to a first gas source; and
a second manifold connected to a second gas source.

24. A method of using a multiple-Venturi nozzle comprising:
(a) inserting said multiple-Venturi nozzle into a pipe;
(b) connecting a manifold nipple on the multiple-Venturi nozzle to a gas source;
(c) allowing a fluid to flow through a plurality of chokes in the multiple-Venturi nozzle.

25. The method of using a multiple-Venturi of claim 24 further comprising:
wherein said fluid is water and said gas is chosen from a group comprising air and oxygen.

26. The method of using a multiple-Venturi of claim 24 further comprising:
wherein said fluid is water and said gas is Fluorine gas.

27. A method of manufacturing a multiple-Venturi nozzle using 3D printing comprising
(a) printing at least one initial layer of material to form a bottom surface, said bottom surface having a plurality of choke inlets formed therein;
(b) printing subsequent layers of material each having:
(i) a plurality of choke cross-sectional openings;
(c) printing further layers of material each having:
(i) a plurality of choke cross-sectional openings; and
(ii) at least one manifold cross-sectional opening;
(d) printing additional layers of material each having a plurality of
(i) choke cross-sectional openings;
(ii) at least one manifold cross-sectional opening; and
(iii) a plurality of manifold channel openings each of which is offset the manifold channel openings of the next layer by the thickness of at least one 3D printed layer of material; and
(e) printing other layers of material having a plurality of
(i) a plurality of choke cross-sectional openings; and
(ii) at least one manifold cross-sectional opening;

28. The method of manufacturing a multiple-Venturi nozzle using 3D printing of claim 27 further comprising:
(f) printing final layers of material having a at least one manifold nipple cross-sectional opening.
